(19) United States
(12) Patent Application Publication
(10) Pub. No.: US 2016/0185574 A1
(43) Pub. Date: Jun. 30, 2016

(54) TRAJECTORY CALCULATION SYSTEM

(71) Applicant: HITACHI, LTD., Tokyo (JP)

(72) Inventors: Atsuko ENOMOTO, Tokyo (JP); Norisuke FUJII, Tokyo (JP); Youichi NONAKA, Tokyo (JP)

(21) Appl. No.: 14/907,838

(22) PCT Filed: Jun. 19, 2014
(86) PCT No.: PCT/JP2014/066240

§ 371 Date: Jan. 27, 2016

(30) Foreign Application Priority Data
Sep. 27, 2013 (JP) 2013-202611

(51) Int. Cl. B66C 15/04; B66C 13/48

(52) U.S. Cl. CPC B66C 15/045; B66C 13/48

(57) ABSTRACT

A technique of calculating a trajectory including preferable suspension posture and arcuate trajectory without interference is provided in relation to the system that calculates the trajectory in the suspension conveyance using conveying equipment. A trajectory calculation system generates a trajectory on which a conveyance object is conveyed on a trajectory including an arcuate trajectory by conveying equipment with a suspension posture between waypoints inside a building; calculates a candidate of the suspension posture of the conveyance object inside the building by using building data, conveyance object data, kinematic parameter of conveying equipment, waypoint information and others; calculates a candidate of the trajectory including the arcuate trajectory; determines presence or absence of interference between the building and the conveyance object in the suspension posture on the trajectory of the candidate; and determines a trajectory including the suspension posture and the arcuate trajectory without interference.

### TECHNICAL FIELD

The present invention relates to a computer and a technique of information processing. In addition, the present invention relates to a technique of calculating a trajectory of a conveyance object.

### BACKGROUND ART

In course of construction of a structure including a building, a plant or the like, a conveyance object such as a material is conveyed between waypoints by suspension conveyance using conveying equipment such as a crane inside the building. This trajectory includes a straight trajectory and an arcuate trajectory. The arcuate trajectory arises when a rail of the crane has an arc-like shape or by an operation of a mechanism such as an axial rotation of the crane. The conveyance object is conveyed while taking a predetermined suspension posture in accordance with a mechanism such as the crane, that is, a state of a predetermined orientation and angle on the trajectory of the path. For example, in the case of the suspension conveyance using a crane device with a predetermined mechanism and a conveyor, the conveyance object is suspended via a wire with respect to a hook and takes a suspension posture in accordance with a gravity force or the like.

Examples of the technique relating to the calculation of the trajectory described above include Japanese Patent Application Laid-Open Publication No. H6-73891 (Patent Document 1). The Patent Document 1 discloses a conveyance system in which a trajectory of a conveying member is determined in path generation means in order to efficiently convey a plurality of articles to a target position in a short time.

### RELATED ART DOCUMENTS

### Patent Documents

Japanese Patent Application Laid-Open Publication No. H6-73891

### SUMMARY OF THE INVENTION

### Problems to be Solved by the Invention

In relation to the trajectory using conveying equipment such as the crane described above, a planner or a designer of construction desires to achieve the reduction in a construction period and construction cost by planning an as efficient trajectory as possible. For its achievement, a system having a function that supports an operator such as the planner by automatically generating the trajectory by using a computer is provided.

As a condition, the trajectory needs to be a realizable path in accordance with the building, the conveyance object and the conveying equipment as application targets. Namely, the trajectory needs to have no interference such as contact between a three-dimensional shape of the conveyance object and three-dimensional shapes of the building and installed object inside or outside the building. In addition, from the viewpoint of efficiency and easiness, the trajectory is desired to have a small change in the operation of conveying equipment such as the crane and a small change in the suspension posture due to the change in the operation thereof. This is because the load on conveying equipment and the conveyor is reduced and it is possible to contribute to the reduction in time and cost.

However, the conventional system relating to the planning and the generation of the trajectory has a room for improvement in relation to the calculation of an efficient trajectory without interference using conveying equipment such as the crane. In particular, the conventional system does not provide the function of calculating the preferable suspension posture and arcuate trajectory without interference.

An object of the present invention is to provide a technique capable of calculating a trajectory including preferable suspension posture and arcuate trajectory without interference and accordingly capable of achieving the reduction in construction period and construction cost, in relation to a system that calculates a trajectory in suspension conveyance using conveying equipment such as the crane.

### Means for Solving the Problems

A representative embodiment of the present invention is a trajectory calculation system which calculates a trajectory in the suspension conveyance using conveying equipment such as the crane, and is characterized by having the following configuration.

The trajectory calculation system according to an embodiment is provided with a calculation device that performs a process of calculating a trajectory on which a conveyance object is conveyed on a trajectory including an arcuate trajectory by conveying equipment with a suspension posture between route points inside a building, and the calculation device includes: a storage unit that stores three-dimensional shape data of the building, three-dimensional shape data of the conveyance object, a kinematic parameter of the conveying equipment and waypoint information; a trajectory calculation unit that generates a candidate of the trajectory including the arcuate trajectory by using the waypoint information; a posture calculation unit that generates a candidate of the suspension posture of the conveyance object by using the three-dimensional shape data of the conveyance object and the kinematic parameter of the conveying equipment; an interference calculation unit that determines an interference state between the suspension posture of the conveyance object on the trajectory and the building with respect to a candidate of the trajectory including the candidate of the arcuate trajectory and the candidate of the suspension posture; a path calculation unit that determines a trajectory including the arcuate trajectory and the suspension posture with which no interference occurs between the conveyance object and the building; and a display unit that displays information including the determined trajectory.

### Effects of the Invention

According to the representative embodiment of the present invention, it is possible to calculate a trajectory including preferable suspension posture and arcuate trajectory without interference, and accordingly, it is possible to achieve the reduction in construction period and construction cost, in relation to the system that calculates the trajectory in the suspension conveyance using conveying equipment such as the crane.

### BRIEF DESCRIPTIONS OF THE DRAWINGS

FIG. 1 is a diagram illustrating a configuration of a calculation device constituting a trajectory calculation system of the first embodiment of the present invention;

FIG. 2 is a diagram illustrating a flow of a control process in the calculation device of the trajectory calculation system of the first embodiment;

FIG. 3 is a diagram illustrating a flow of a calculation process of the trajectory in the calculation device of the trajectory calculation system of the first embodiment;

FIG. 4 is a diagram illustrating examples of a building and a trajectory;

FIG. 5 is a diagram illustrating examples of a kinematic parameter and suspension posture of a conveyance object;

FIG. 6 is a diagram illustrating a model for calculation of the suspension posture in the case of a crane device;

FIG. 7 is an explanatory diagram relating to generation of an arcuate trajectory based on waypoint information;

FIG. 8 is an explanatory diagram relating to a change of a distance L and a curvature radius r in relation to the generation of the arcuate trajectory;

FIG. 9 is an explanatory diagram illustrating a first angle φ to define the suspension posture;

FIG. 10 is an explanatory diagram relating to a process of setting an initial value of the suspension posture in a direction parallel to a path tangent;

FIG. 11 is a diagram illustrating an example of a way and an order to set a candidate of an interference determination target as a supplement relating to the calculation process of FIG. 3;

FIG. 12 is an explanatory diagram relating to the interference determination between the building and the conveyance object on the trajectory;

FIG. 13 is a diagram illustrating a method of changing the arcuate trajectory as the example of the trajectory;

FIG. 14 is a diagram illustrating an example of presence of interference in the method of changing the arcuate trajectory as the example of the trajectory;

FIG. 15 is a diagram illustrating an example of absence of interference in the method of changing the arcuate trajectory as the example of the trajectory;

FIG. 16 is a diagram illustrating an example in which a long axis direction of the conveyance object is set to a direction parallel to a tangential direction of a path in a method of changing the suspension posture as the example of the trajectory;

FIG. 17 is a diagram illustrating an example in which the long axis direction of the conveyance object is set to a direction vertical to the tangential direction of the path in the method of changing the suspension posture as the example of the trajectory;

FIG. 18 is a diagram illustrating an example in which the suspension posture is changed between an end point of a first trajectory and a start point of a second trajectory in the method of changing the suspension posture as an example of the trajectory and an evaluation process;

FIG. 19 is a diagram illustrating an example of a screen in the calculation device of the trajectory calculation system of the first embodiment; and

FIG. 20 is an explanatory diagram relating to a process of setting the initial value of the suspension posture based on a three-dimensional shape of the conveyance object in a calculation device of a trajectory calculation system of the second embodiment of the present invention.

### DETAILED DESCRIPTION OF PREFERRED EMBODIMENTS

Hereinafter, embodiments of the present invention will be described in detail with reference to the accompanying drawings. Note that components having the same function are denoted by the same reference signs throughout the drawings for describing the embodiments, and the repetitive description thereof will be omitted in principle.

### First Embodiment

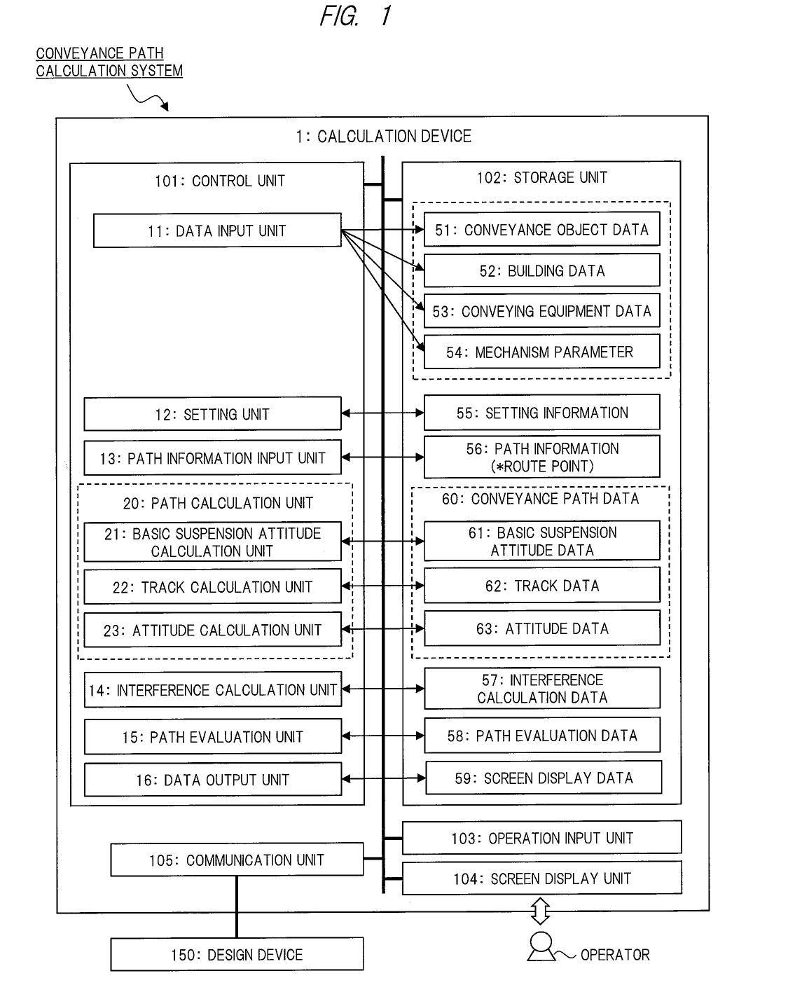

A trajectory calculation system of the first embodiment of the present invention will be described with reference to FIGS. 1 to 19. This trajectory calculation system is a system that performs calculation and information processing to generate or plan a trajectory including a suspension posture of a conveyance object and an arcuate trajectory in a situation of suspension conveyance in which the conveyance object is conveyed in the state of being suspended by conveying equipment such as a crane inside or outside a building to be constructed. This trajectory calculation system provides a function of calculating a trajectory in which there is no interference between the building and the conveyance object and a preferable trajectory in which the load on conveying equipment and the conveyor is small. The trajectory calculation system generates the trajectory including an arcuate trajectory so that there is no interference between the conveyance object taking the suspension posture in accordance with the conveying equipment and the surrounding building.

The trajectory calculation system is provided with a function of calculating the trajectory including the suspension posture and the arcuate trajectory by using a method of physics and mathematics including a kinetic analysis. The trajectory calculation system calculates or sets the suspension posture in accordance with the law of physics such as an equation of motion as a basic suspension posture. Accordingly, it is possible to achieve a highly accurate planning of the trajectory.

The trajectory calculation system of this embodiment includes the following functions (1) and (2). An operator can select and use any one of these functions.

(1) This system includes a function of generating a trajectory having a small curvature of the arcuate trajectory without interference. This system generates a preferable trajectory in which a curvature radius of the arcuate trajectory can be increased as much as possible while avoiding the interference when calculating the above-described trajectory. Accordingly, the efficiency of conveyance is improved by utilizing an arcuate operation such as pivoting by the conveying equipment such as the crane.

(2) This system includes a function of generating a trajectory having a small change of the suspension posture without interference. This system generates a preferable trajectory in which the suspension posture in accordance with the law of physics is maintained as much as possible to suppress the change thereof to a minimum under a range and condition in which there is no interference with the building at the time of the above-described calculation of the trajectory. Accordingly, a load to change the suspension posture of the conveyance object on the trajectory by an operation of the conveying equipment or work of the conveyor is reduced.

This system may be embodied as a mode provided with only the above-described function (1) of generating the trajectory from the viewpoint of the preferable arcuate trajectory, or may be embodied as a mode provided with only the above-described function (2) of generating the trajectory from the viewpoint of the preferable suspension posture.

This system generates a trajectory in which there is no interference, a curvature of the arcuate trajectory is small, and a change of the suspension posture is small as a combined function of the above-described functions (1) and (2). This system may be embodied as a mode provided with a function of generating a preferable trajectory by placing priority more on the viewpoint of the arcuate trajectory in (1) than the viewpoint of the suspension posture in (2) described above. Alternatively, this system may be embodied as a mode provided with a function of generating a preferable trajectory by placing priority more on the viewpoint of the suspension posture in (2) than the viewpoint of the arcuate trajectory in (1) described above.

[Calculation Device]

FIG. 1 illustrates a configuration of a calculation device 1 constituting the trajectory calculation system of the first embodiment. The calculation device 1 has a control unit 101, a storage unit 102, an operation input unit 103, a screen display unit 104 and a communication unit 105. The calculation device 1 may be connected to a different device, for example, a design device 150 via a communication network. The design device 150 stores data of the building, the conveyance object, the conveying equipment and the like in a design DB (database).

The control unit 101 is provided with a CPU, ROM, RAM and the like, and realizes each processing unit by program processing. The storage unit 102 includes a primary storage device, a secondary storage device and the like. The operation input unit 103 includes a keyboard, a mouse, a touch panel and the like, and performs a process of inputting an instruction and each data or information of the calculation based on an operation of the operator of the calculation device 1. The screen display unit 104 includes a display, and performs a process of displaying information on a screen for the operator. The communication unit 105 includes communication interface with respect to the communication network, and performs a communication process with the design device 150 and the like.

The control unit 101 includes a data input unit 11, a setting unit 12, a path information input unit 13, a path calculation unit 20, an interference calculation unit 14, a path evaluation unit 15 and a data output unit 16. The path calculation unit 20 includes a basic suspension posture calculation unit 21, a trajectory calculation unit 22 and a posture calculation unit 23.

The storage unit 102 stores conveyance object data 51, building data 52, conveying equipment data 53, a kinematic parameter 54, setting information 55, path information 56, waypoint data 60, interference calculation data 57, path evaluation data 58 and screen display data 59. The waypoint data 60 includes basic suspension posture data 61, trajectory data 62 and posture data 63.

The trajectory calculation system is not limited to the configuration of the calculation device 1 described above, and may be configured by being connected with a different device, or may be configured by connections of a plurality of calculation devices. For example, the trajectory calculation system may be configured of different calculation devices such as servers provided for each processing unit.

[Control Process]

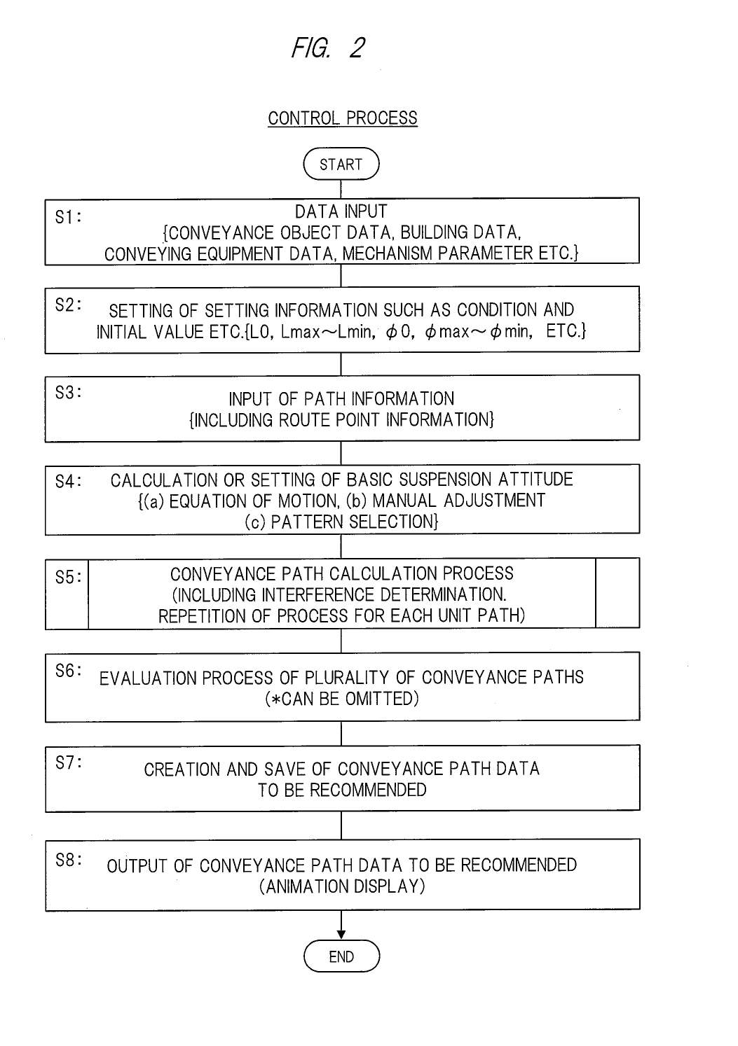

FIG. 2 illustrates a flow of the entire control process by the calculation device 1 of the trajectory calculation system of the embodiment. Reference numerals S1 and the like indicate process steps.

(S1: Data Input) In step S1, a process of inputting each data required for the calculation is performed by the data input unit 11. The data input unit 11 inputs the data including the conveyance object data 51, the building data 52, the conveying equipment data 53, the kinematic parameter 54 and the like, and stores the input data in the storage unit 102. The conveyance object data 51, the building data 52 and the conveying equipment data 53 are, for example, STL files each of which includes data of a model with a three-dimensional shape. The data input unit 11 may acquire an STL file of each data managed in a design DB of the design device 150.

The kinematic parameter 54 is information that defines a parameter in accordance with a mechanism of an axial rotation, suspension or the like of the conveying equipment such as the crane. For example, this parameter indicates in which axis or range the conveyance object can be rotated and moved as an operation of a crane device, and is unique for each conveying equipment as an application target. Note that the kinematic parameter 54 may be input in S2.

(S2: Setting) In step S2, a setting process of a calculation condition and various types of set values as the setting information 55 is performed based on the operation of the operator by the setting unit 12. At this time, the screen display unit 104 displays a screen for setting. The operator inputs and confirms the setting information on the screen.

As described later, the setting information 55 includes, for example, a value to define a variable range of a distance L (Lmin to Lmax) or a curvature radius r that defines the arcuate trajectory and a value to define a variable range of an angle φ (φmin to φmax) that defines the suspension posture. In addition, the setting information 55 includes an initial value L0 of the distance L, an initial value φ0 of the angle φ and the like.

(S3: Path Information Input) In step S3, an input process of the path information 56 is performed based on the operation of the operator by the path information input unit 13. The path information 56 includes waypoint information given as an initial input for the calculation of the trajectory. The waypoint information includes at least specification of a start point and an end point of the trajectory.

The path information input unit 13 displays items for inputting the path information on the screen similarly to the process of the setting unit 12 to allow the operator to input in the input process of the path information 56. In addition, in the case in which there is path information including only a straight trajectory that has been generated by an existing path generation function, it is possible to use the path information.

(S4: Basic Suspension posture) In step S4, a process of calculating or setting a basic suspension posture is performed by the basic suspension posture calculation unit 21, and a result thereof is stored in the basic suspension posture data 61. In S4, the basic suspension posture is calculated or set by the following means and method. The operator can select and use any means thereof. The calculation device 1 calculates a trajectory including a suspension posture at each point on the trajectory based on the basic suspension posture obtained in S4 while adding a change if necessary in S5 and subsequent steps.

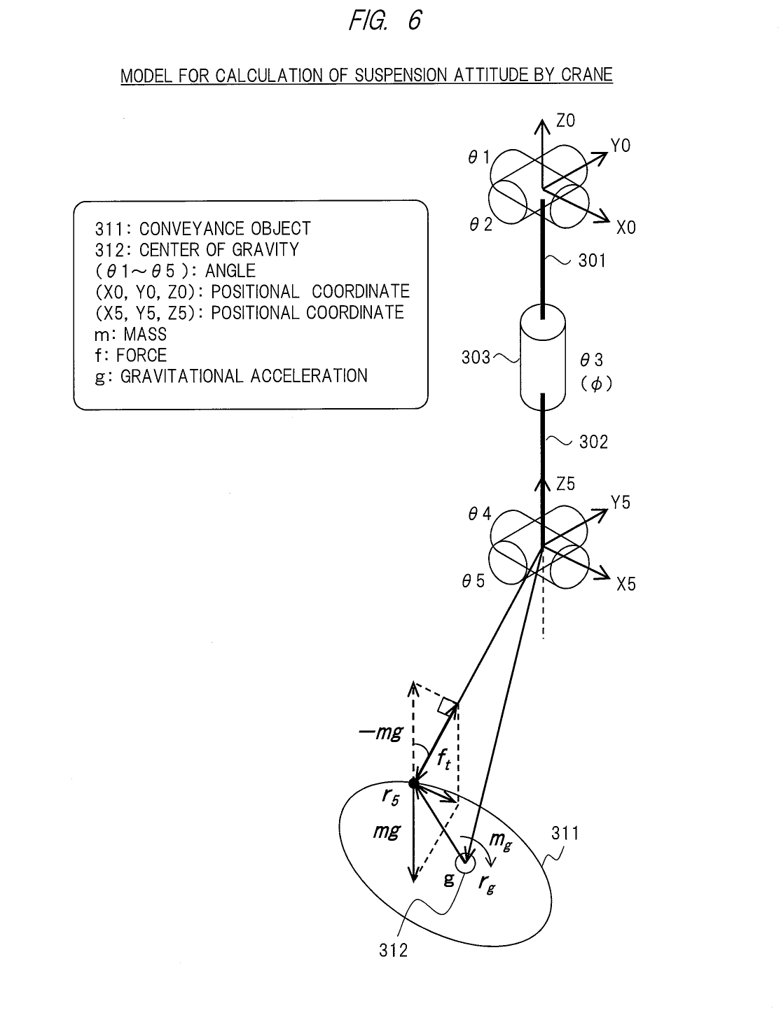

(a) As first means, the basic suspension posture calculation unit 21 calculates a suspension posture in accordance with the kinematic parameter 54 of the conveying equipment such as the crane and the law of physics by using a calculation model including an equation of motion to be described later, and stores the calculated suspension posture as the basic suspension posture. The basic suspension posture calculation unit 21 establishes the equation of motion relating to a suspended state of the conveyance object by the conveying equipment based on the calculation model as illustrated in FIG. 6 to be described later by using a value of the kinematic parameter 54 read out from the storage unit 102. Further, the basic suspension posture calculation unit 21 solves the equation of motion, thereby obtaining the suspension posture in accordance with the law of physics. In the case of using the means (a), it is possible to realize highly accurate calculation of the trajectory.

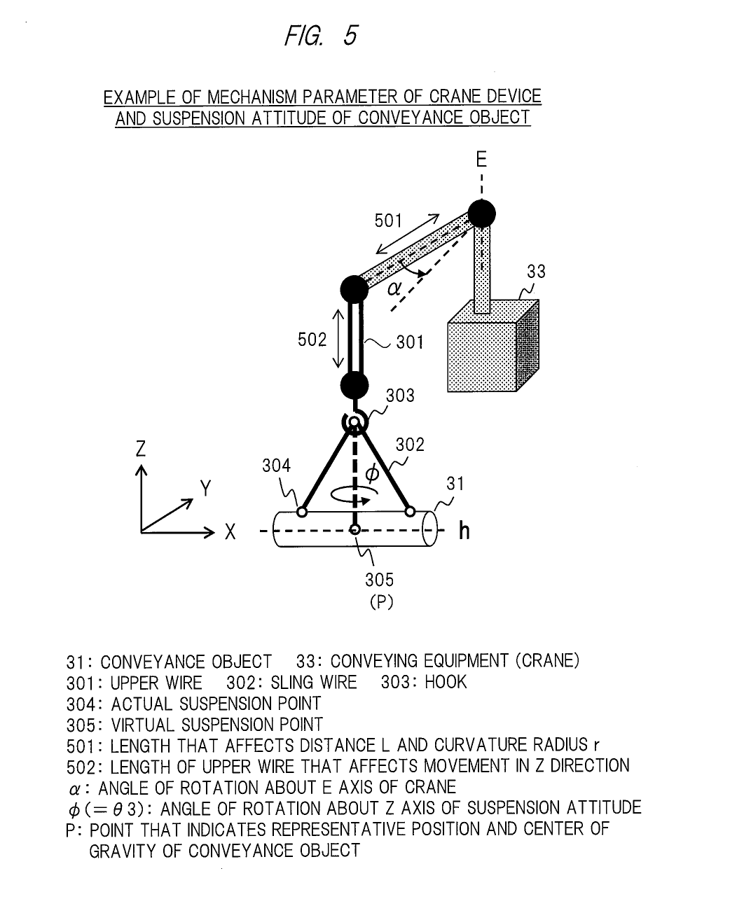

(b) As second means, the basic suspension posture calculation unit 21 sets the basic suspension posture through manual adjustment by the operation of the operator on the screen. The basic suspension posture calculation unit 21 displays a screen for setting the suspension posture. This screen displays, for example, a three-dimensional or two-dimensional graphical shape of the suspension posture of a conveyance object 31 as illustrated in FIG. 5 to be described later. The operator manually adjusts a position and an angle of the conveyance object with respect to the conveying equipment to be in a desired state on the screen. The basic suspension posture calculation unit 21 sets a value of the basic suspension posture in accordance with the state of the adjusted suspension posture.

(c) As third means, the basic suspension posture calculation unit 21 prepares a plurality of patterns of suspension posture calculated in advance, and sets a pattern selected based on the operation by the operator on the screen as the basic suspension posture. The calculation device 1 may preliminarily set the suspension posture obtained by the calculation of (a) as the pattern. The calculation device 1 may preliminary set the suspension posture by the manual adjustment of (b) as the pattern. The calculation device 1 may preliminarily set a pattern of the suspension posture in accordance with various types of representative kinematic parameters of the conveying equipment. The calculation device 1 stores information of the above-described pattern of the suspension posture in the storage unit 102 as, for example, a part of the setting information 55.

The calculation device 1 may perform the manual adjustment of (b) additionally to the basic suspension posture calculated in (a) and the pattern selected in (c). In the case of using the means of (b) and (c) above, it is possible to easily calculate the trajectory in a short time.

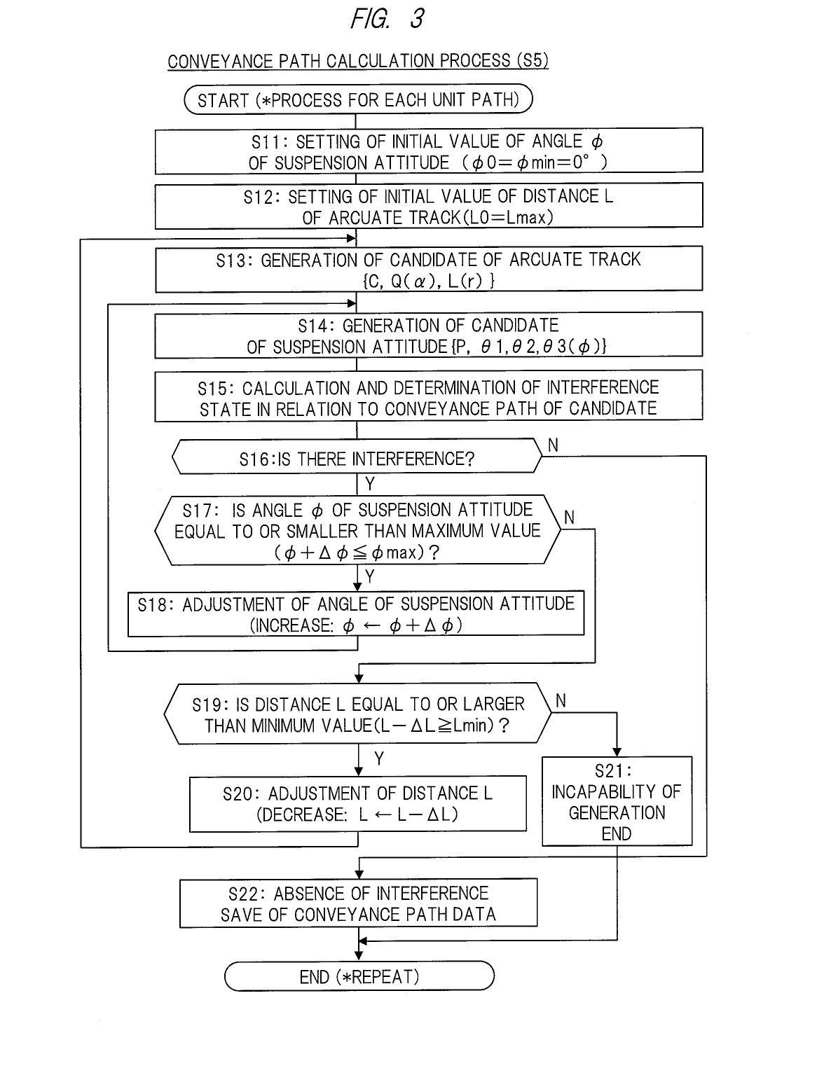

(S5: Path Calculation) In step S5, a path calculation process illustrated in FIG. 3 to be described later is performed by the path calculation unit 20, and a result thereof is stored in the waypoint data 60. The path calculation unit 20 generates a trajectory that connects waypoints specified in the path information 56. This trajectory includes the arcuate trajectory and the suspension posture by the conveying equipment such as the crane. The path calculation unit 20 performs a process of calculating one trajectory with using, for example, three waypoints as a single unit. The path calculation unit 20 repeats the calculation with the above-described unit in the same manner for four or more successive waypoints.

The path calculation unit 20 generates a trajectory that connects the start point and the end point of the given waypoints by the trajectory calculation unit 22. This trajectory is made up by the combination of the straight trajectory and the arcuate trajectory. The trajectory calculation unit 22 generates a trajectory including the above-described arcuate trajectory as a candidate by using the kinematic parameter 54 and the path information 56, and stores the trajectory in the trajectory data 62.

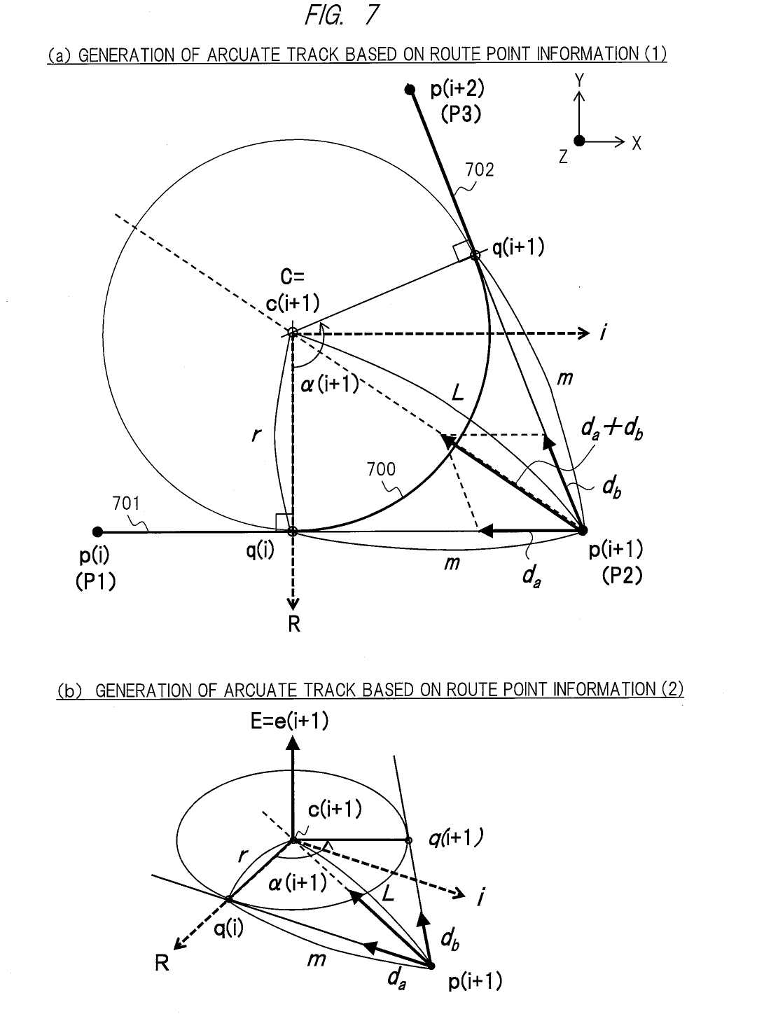

The trajectory calculation unit 22 sets a reference point and a center point of an arc in the successive waypoints as illustrated in FIG. 7 and the like to be described later, and generates the distance L between the reference point and the center point and the curvature radius r which is a radius of the arc from the center point. The trajectory calculation unit 22 generates a tangent point of the arc with respect to a straight line segment that passes through an initial waypoint as a waypoint to be the start point or the end point of the arcuate trajectory. The arcuate trajectory is defined by using the distance L or the curvature radius r described above and the tangent point (start point or end point) or an angle α about the rotation axis of the center point corresponding thereto. As a process of adjusting the distance L and the curvature radius r, the trajectory calculation unit 22 generates a candidate of the arcuate trajectory by increasing or decreasing the distance L and the curvature radius r by a predetermined pitch width (ΔL, Δr).

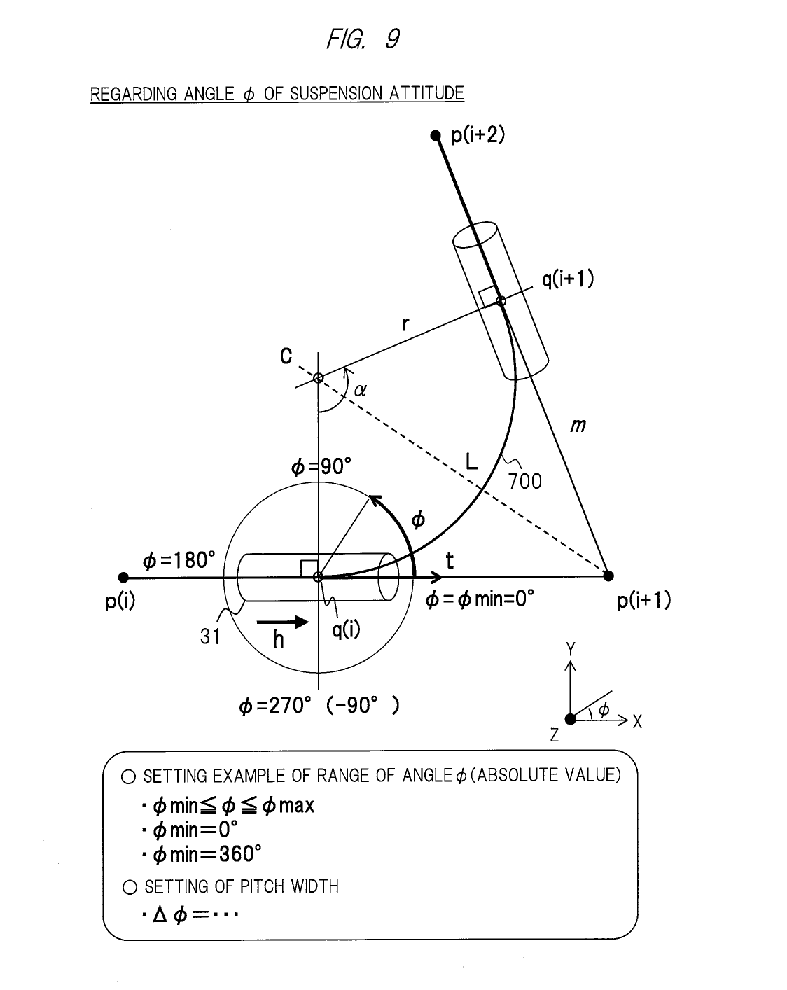

The path calculation unit 20 generates a suspension posture of the conveyance object on the above-described trajectory as a candidate by the posture calculation unit 23, and stores the candidate in the posture data 63. The posture calculation unit 23 performs a process of adjusting an angle to define the suspension posture based on the basic suspension posture in accordance with the kinematic parameter 54 and the basic suspension posture data 61. As illustrated in FIG. 9 to be described later, the posture calculation unit 23 increases or decreases the angle φ and the like to define the suspension posture by a predetermined pitch width (Δφ), thereby generating a candidate of the suspension posture.

The path calculation unit 20 invokes the interference calculation unit 14 to make the interference calculation unit 14 perform interference determination for the trajectory including the arcuate trajectory and the suspension posture generated as the candidate described above. When a result of the interference determination is the absence of interference, the path calculation unit 20 saves data of the trajectory as a valid candidate. When a result of the interference determination is the presence of interference, the path calculation unit 20 rejects the trajectory as an invalid candidate, and generates another candidate by adjusting a variable of the arcuate trajectory or the suspension posture in the candidate.

In S5, the path calculation unit 20 determines one or more preferable trajectories without interference as the result of the calculation described above, and stores the information thereof in the waypoint data 60. The path calculation unit 20 repeats the process until a trajectory without interference is found, while performing the interference determination in the same manner for each candidate of the trajectory generated by the adjustment.

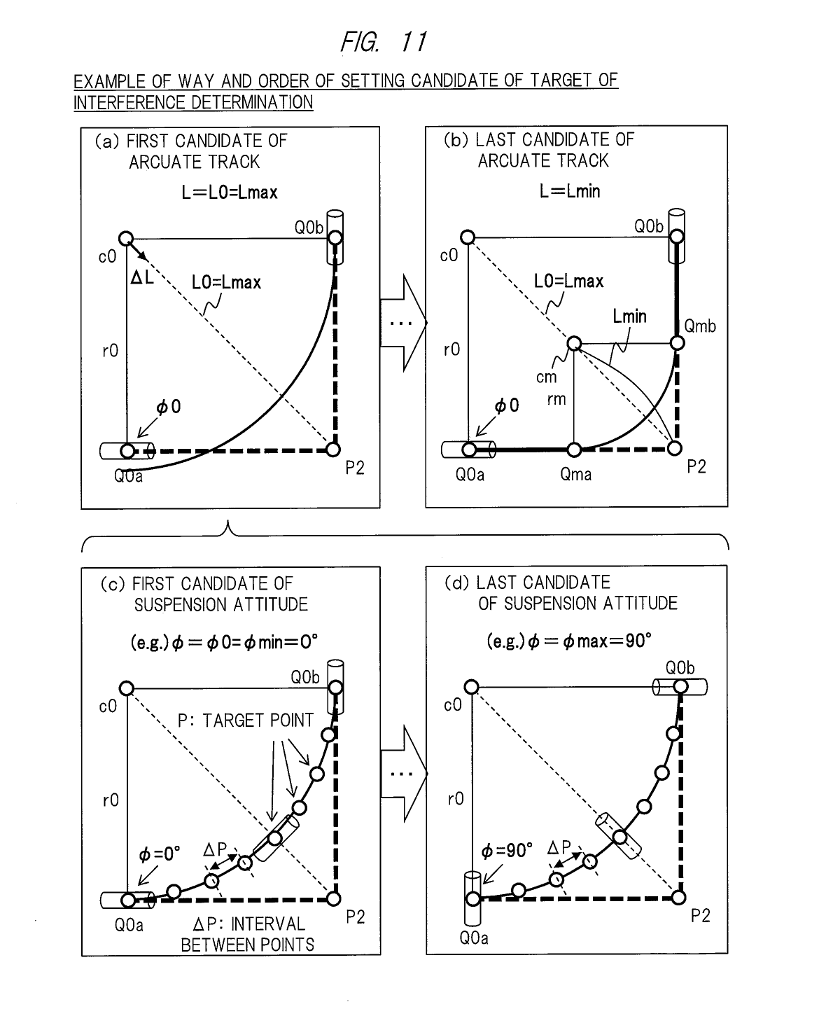

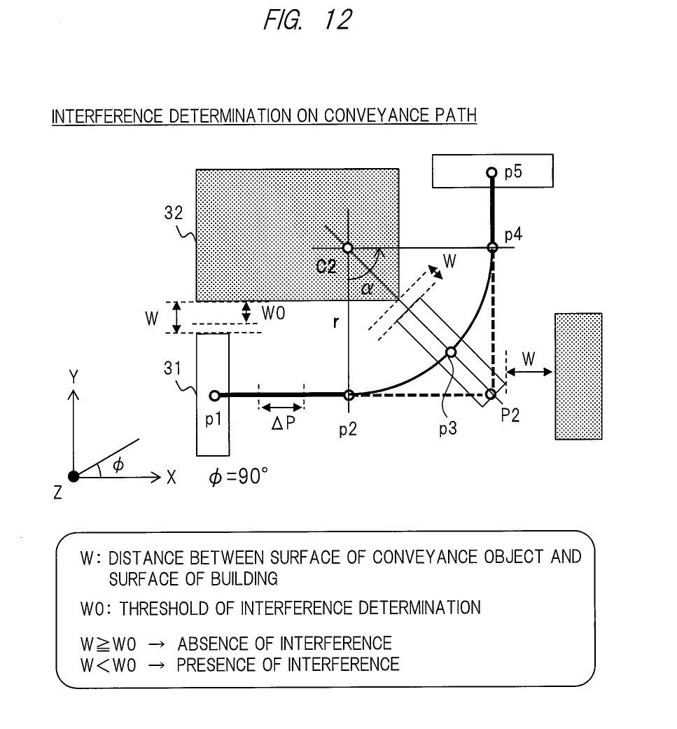

The path calculation process of S5 includes an interference determination process performed by the interference calculation unit 14. The interference calculation unit 14 performs the interference determination process as follows, and stores data in the middle of and as a result of the process in the interference calculation data 57. The interference calculation unit 14 calculates a degree of interference between the conveyance object 31 and the surrounding building 32 for each suspension posture at a point of a position of the conveyance object on trajectory of the candidate, and determinates and checks the presence or absence of the interference. The interference calculation data 57 includes information about the presence or absence of interference for each point of the position of the conveyance object on the trajectory and each suspension posture. A known algorithm can be applied to the interference calculation. FIG. 12 to be described later illustrates an example of the interference determination process.

An interference calculation unit 17 saves the result of the interference calculation in the interference calculation data 57, and returns the information including the presence or absence of interference to the path calculation unit 20. The path calculation unit 20 sets a candidate without interference as a preferable candidate by using the information including the presence or absence of interference, and rejects a candidate with interference or considers a change of the arcuate trajectory or the suspension posture regarding the candidate with interference.

(S6: Path Evaluation) In step S6, when there are a plurality of trajectories calculated in the process up to S5, the path evaluation unit 15 performs a predetermined evaluation process regarding which of these trajectories are efficient trajectories, and determines one or more trajectories to be recommended from the result thereof. The path evaluation unit 15 stores the result of the evaluation process in the path evaluation data 58. The viewpoints of evaluation include the viewpoint of efficiency and easiness described above. Namely, the path evaluation unit 15 gives a high evaluation value to a trajectory whose curvature radius r of the arcuate trajectory is large totally among one or a plurality of trajectories. Alternatively, for example, the path evaluation unit 15 gives a high evaluation value to a trajectory whose change in suspension posture is small totally among one or a plurality of trajectories. The path evaluation unit 15 sequentially recommends the trajectories in the order of higher to lower evaluation value.

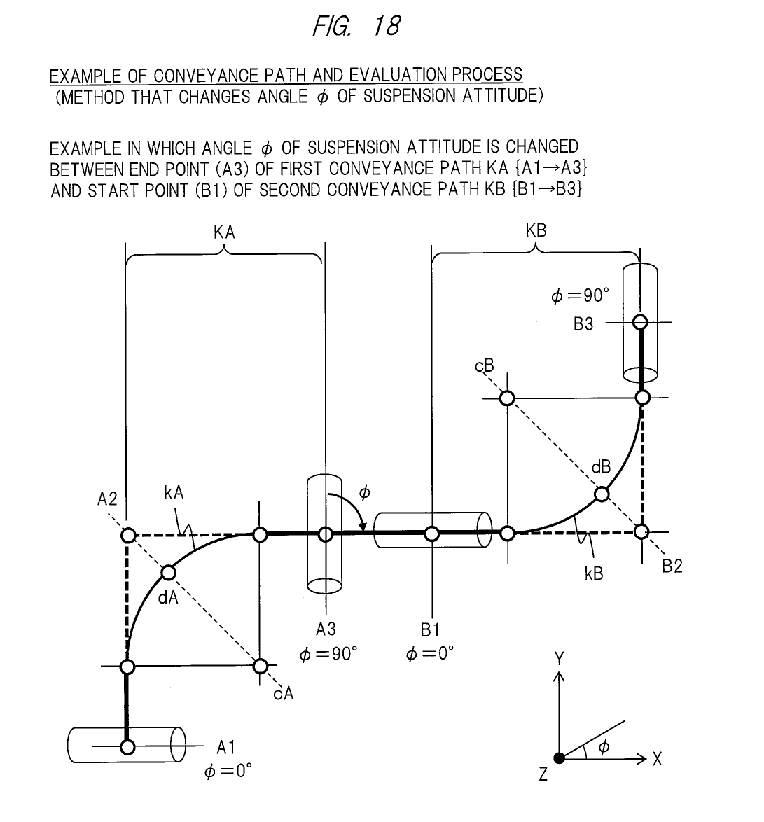

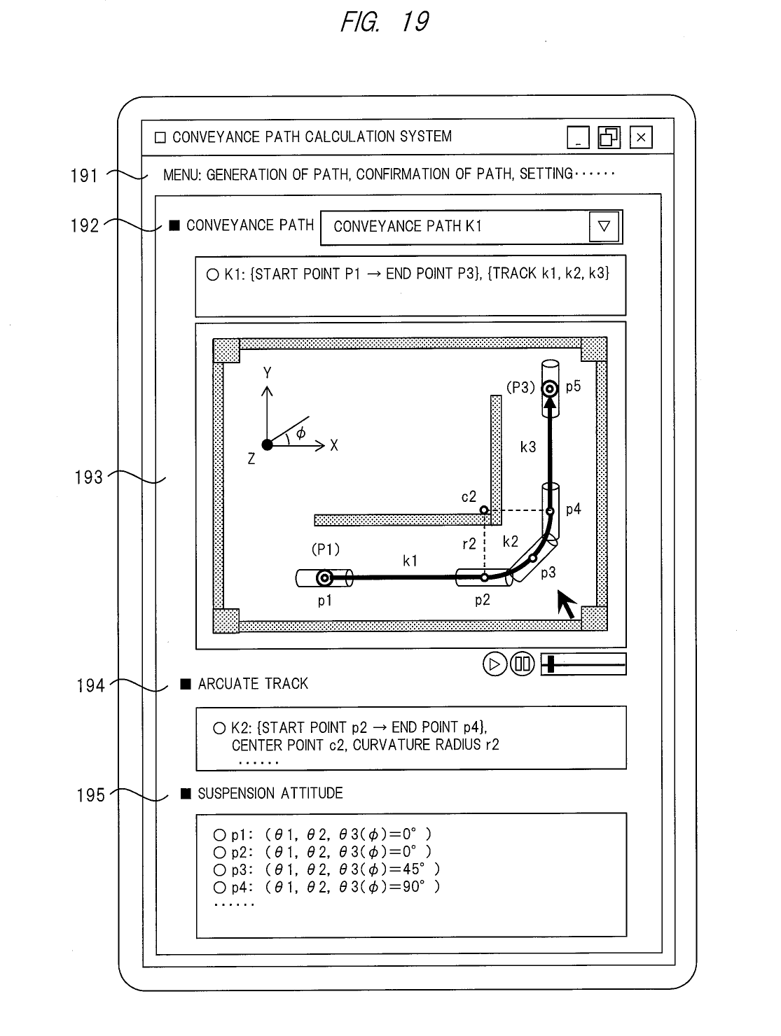

Incidentally, a mode in which the evaluation process of S6 is omitted and the result of S5 is directly output is also possible. Note that the evaluation process of S6 and the evaluation process during the interference determination of S5 are different processes. FIG. 18 to be described later illustrates an example of the evaluation process.

(S7: Data Save) In step S7, the path calculation unit 20 collects information of one or more trajectories to be recommended based on the results up to S5 or S6 in the waypoint data 60, and saves the waypoint data 60 in the storage unit 102.

(S8: Data Output) In step S8, the data output unit 16 performs a process of outputting the one or more trajectories to be recommended by this system by using the waypoint data 60 obtained up to S7 or the information of the trajectory arbitrarily selected by the operator. The data output unit 16 performs a process of reading out the waypoint data 60 and displaying the information of the trajectory in a form of an animation video or the like on the screen. The data output unit 16 creates data to be displayed on the screen as the screen display data 59 by using the conveyance object data 51, the building data 52 and the like.

In the animation display on the screen, for example, a three-dimensional object of the conveyance object in accordance with the position and the suspension posture on the trajectory in a three-dimensional space inside a building is displayed. In the animation display, a state of the suspension posture of the conveyance object to be displayed is changed along with the movement of the conveyance object on the trajectory. In this display, the state of the suspension posture of the conveyance object and an interference state with the surroundings at each position from the start point to the end point on the trajectory are displayed.

The operator and the conveyor can confirm a movement and a state of the conveyance object on the trajectory by viewing video or a still image of the animation. Namely, the operator and the conveyor can easily confirm with which trajectory and suspension posture the conveyance work should be performed. The conveyor can view the display in the same manner as the operator by downloading the data of the calculation device 1 onto a screen of a terminal device that the conveyor has. The data output is not limited to the above-described animation display, and a two-dimensional map display is also possible.

[Path Calculation Process]

FIG. 3 illustrates a flow of a specific example of the path calculation process performed by the path calculation unit 20 in S5 of FIG. 2. Note that FIG. 3 illustrates the flow in which a process of calculating one trajectory that connects three waypoints is set as a single unit (referred to as a unit path) and the process of the unit path is repeated in the same manner. In addition, the process example of FIG. 3 illustrates an example in which an efficient trajectory without interference is obtained while adjusting both the distance L of the arcuate trajectory and the angle φ of the suspension posture. In addition, the process example of FIG. 3 illustrates an example in which the adjustment of the distance L is performed in priority to the adjustment of the angle φ.

Note that FIG. 11 illustrates an example of a way and an order to set a plurality of candidates to be targets of the interference determination in correspondence with the process example of FIG. 3 as a supplement of FIG. 3.

(S11) In step S11, the path calculation unit 20 and the posture calculation unit 23 set an initial value relating to an angle of the suspension posture of the conveyance object for the calculation of the unit path. An initial value of a first angle φ to define the suspension posture is set as φ0. The initial value φ0=φmin=0° is set in the first embodiment. A reference sign φmin is a minimum value in a range that the angle φ can take based on the kinematic parameter 54. Here, a traveling direction on the trajectory and a direction parallel to the tangent of the arcuate trajectory are relatively set as φmin=0°. Note that the initial value φ0 of the angle φ can be set to a different value.

(S12) In step S12, the path calculation unit 20 and the trajectory calculation unit 22 set initial values relating to the distance L and the curvature radius r to define the arcuate trajectory of the conveyance object for the calculation of the unit path. The initial value of the distance L is set as L0. The initial value L0=Lmax is set in the first embodiment. A reference sign Lmax is a maximum value in a range that the distance L can take based on the kinematic parameter 54. Note that, since the distance L and the curvature radius r can be obtained through a simple conversion, the calculation relating to the distance L can be regarded as the calculation relating to the curvature radius r. Note that the initial value L0 of the distance L can be set to a different value.

(S13) In step S13, the path calculation unit 20 generates a candidate of the arcuate trajectory by the trajectory calculation unit 22. The candidate of the arcuate trajectory is defined by a center point C with respect to the reference point of the arc, a waypoint Q which is the tangent point, the start point or the end point of the arc (or the angle α having the center point C as the rotation axis), the distance L between the reference point of the arc and the center point C (or the curvature radius r) and the like.

(S14) In step S14, the path calculation unit 20 generates a candidate of the suspension posture by the posture calculation unit 23. The candidate of the suspension posture is defined by an angle of posture (θ1, θ2 or θ3) at a position of a waypoint P and the like. A reference sign θ3 is the angle φ about a Z axis.

(S15) In step S15, the path calculation unit 20 makes the interference calculation unit 17 perform the calculation and determination of an interference state for the candidate of the trajectory in which the candidate of the arcuate trajectory obtained in S13 and the candidate of the suspension posture obtained in S14 are combined. The interference calculation unit 14 calculates an interference state between a three-dimensional shape of the conveyance object 31 and a three-dimensional shape of the surrounding building 32 at a point (including an interpolation point) of each position on the trajectory of the candidate. The interference calculation unit 17 returns a result of the presence or absence of interference in the candidate of the trajectory.

(S16) In step S16, the path calculation unit 20 refers to the result of the interference determination of S16, and proceeds to S17 in the case in which there is interference (Y) and proceeds to S22 in the case in which there is no interference (N).

(S17) In step S17, the path calculation unit 20 determines that adjustment is necessary since there is interference in the candidate of the trajectory described above, and moves to the adjustment of the angle of the suspension posture. The path calculation unit 20 confirms whether the angle φ of the suspension posture on the trajectory is equal to or less than the maximum value of the adjustable range (φ+Δφ≦φmax) while considering the predetermined pitch width Δφ. The process proceeds to S18 in the case in which φ+Δφ≦φmax (Y), and proceeds to S19 in the other case (N).

(S18) In step S18, the path calculation unit 20 adjusts the current angle φ of the suspension posture on the trajectory by the posture calculation unit 23. The posture calculation unit 23 increases the current angle φ of the suspension posture described above by the predetermined unit of the pitch width Δφ (φ→φ+Δφ). Returning to S14 from S18, the posture calculation unit 23 generates a candidate of the suspension posture corresponding to the angle φ increased in S18 in the same manner. Then, the interference determination is performed with respect to the changed candidate of the suspension posture in the same manner in S15.

(S19) In step S19, the path calculation unit 20 confirms whether the distance L of the arcuate trajectory is equal to or more than the minimum value of the adjustable range (L-ΔL≧Lmin) while considering the predetermined pitch width ΔL. The process proceeds to S20 in the case in which L-ΔL≧Lmin (Y), and proceeds to S21 in the other case (N).

(S20) In step S20, the path calculation unit 20 adjusts the distance L of the above-described arcuate trajectory by the trajectory calculation unit 22. The trajectory calculation unit 22 decreases the current distance L of the above-described arcuate trajectory by the unit of the pitch width ΔL (L←L-ΔL). Then, the process returns to S13 from S20. In the case of returning to S13, the trajectory calculation unit 22 generates a new candidate of the arcuate trajectory corresponding to the distance L decreased in S20 in the same manner.

(S21) In step S21, the unit path being processed in which the angle φ and the distance L cannot be changed any more indicates that it is impossible to generate the trajectory without interference. Thus, the process for such a unit path ends here due to incapability of generation.

(S22) In step S22, since the candidate of the trajectory without interference is found in S16, the information of this trajectory without interference is saved in the waypoint data 60, and the process ends. This trajectory without interference is a trajectory that is obtained by decreasing the distance L of the arcuate trajectory gradually from the desirable initial value L0 and increasing the angle φ of the suspension posture gradually from the desirable initial value φ0. Note that, although the process ends at the time when one trajectory without interference is obtained in the process example described above, a plurality of trajectories without interference may be found by searching all possibilities.

Through a series of processes described above, the calculation device 1 searches a preferable trajectory in which there is no interference, the arcuate trajectory in which the distance L is as close as possible to the initial value L0=Lmax and the curvature radius is large is included, and the change of the suspension posture is small while keeping the angle φ at the initial value φ0=0° as far as possible.

In the supplement illustrated in FIG. 11, (a) illustrates the first candidate of the arcuate trajectory in which the distance L=L0=Lmax. Also, (b) illustrate the last candidate of the arcuate trajectory in which L=Lmin. Candidates obtained by decreasing the distance L by the pitch width ΔL are generated between the candidate of (a) and the candidate of (b).

Further, (c) illustrates the first candidate of the suspension posture in relation to the candidate of the arcuate trajectory of (a). Namely, the case in which the angle φ=φ0=φmin=0° is illustrated. A relative angle of the posture on the trajectory is maintained. Also, (d) illustrates the last candidate of the suspension posture in relation to the candidate of the arcuate trajectory of (a). Here, the case in which the angle φ=φmax=90° is illustrated as an example. Candidates obtained by increasing the angle φ by the pitch width Δφ are generated between the candidate of (c) and the candidate of (d).

In the cases of (c) and (d), the path calculation unit 20 sets a plurality of points P serving as targets of interference determination on the straight and arcuate trajectory as the interpolation points in relation to the candidates of the trajectory and the suspension posture. For example, the plurality of points P are set at predetermined intervals ΔP. The suspension posture is taken at the point P of each of the plurality of positions. For example, in the state of (c), the relative angle φ of the suspension posture at each of the points P on the arcuate trajectory is maintained based on an angle φ0=0° at a start point Q0a of the arc. If it is expressed in terms of an absolute value of the angle φ in an absolute coordinate system, φ=0° at the start point Q0a and φ=90° at an end point Q0b. The same is true of the state of (d). The relative angle φ of the suspension posture at each of the points P on the arcuate trajectory is maintained based on the angle φ0=90° at the start point Q0a of the arc. If it is expressed in terms of the absolute value of the angle φ in the absolute coordinate system, φ=90° at the start point Q0a and φ=180° at the end point Q0b. The interference determination as described above is performed in the same manner for the suspension posture at each of the interpolation points.

[Conveyance Object, Building and Trajectory]

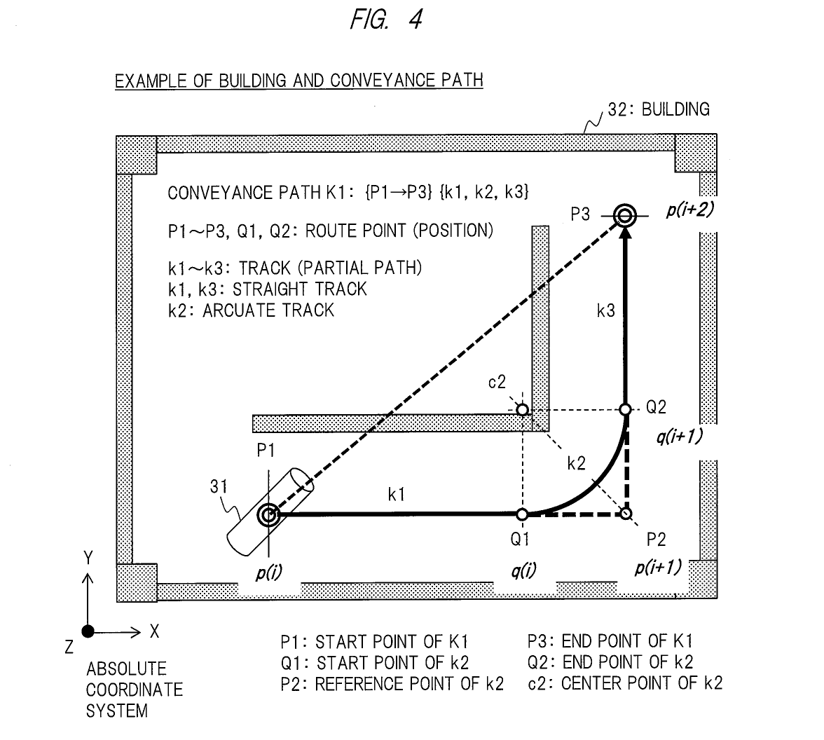

FIG. 4 illustrates examples of the conveyance object 31, the building 32, the trajectory and the like. An example of the application target of this system is the construction of the building 32 designed in a predetermined manner, and a trajectory of the conveyance object 31, for example, a material for forming the building 32 is planned. (X, Y, Z) represents an absolute coordinate system, and X and Y are directions forming a horizontal plane and Z is a vertical direction. The conveyance object 31 illustrates an example of a material having a cylindrical shape. The building 32 illustrates an example in which an L-shaped wall is present inside a rectangular wall as an example of an XY cross section. In addition, though not shown, conveying equipment such as the crane is provided, and it is used for conveyance on at least the arcuate trajectory.

A trajectory K1 is a trajectory that connects a start point P1 and an end point P3 via an intermediate point P2, and is made up of the connection of a plurality of trajectories, for example, a straight trajectory k1, an arcuate trajectory k2 and a straight trajectory k3. The straight trajectory k1 is from a waypoint P1 as the start point to a waypoint Q1. The arcuate trajectory k2 is from the waypoint Q1 to a waypoint Q2. The straight trajectory k3 is from the waypoint Q2 to a waypoint P3 of the end point. The waypoint P2 is a reference point of generation of the arcuate trajectory k2, and is a point where no direct passage is made when passing through the arcuate trajectory k2. A reference numeral c2 denotes the center point of the arcuate trajectory k2. Each waypoint corresponds to a point that indicates a representative position of the conveyance object. Note that the points corresponding to the following descriptions are illustrated as a point p(i) and the like.

For the generation of one trajectory, the three point P1, P2 and P3 are specified as the waypoint information. Alternatively, for the generation of one trajectory, the two points P1 and P3 are specified as the waypoint information, and the system automatically sets the point P2.

For sake of description, the trajectory includes a plurality of the waypoints and a trajectory which is a partial path that connects between the waypoints, and the trajectory includes a straight trajectory and an arcuate trajectory. The trajectory includes a start point and an end point. The arcuate trajectory is defined by a center point, a curvature radius, a rotation angle and the like of the arc. In addition, the information of the trajectory is defined as information including information of the suspension posture of the conveyance object on the trajectory, but the information of the trajectory and the information of the suspension posture may be managed so as to be separately associated with each other. The posture is defined by an orientation and an angle, and is defined by, for example, an angle of rotation about three axes of (X, Y, Z) which is Cartesian coordinate system.

Note that the shape of the building 32 is changed along with the progress of the construction. The building data 52 may be data including the shapes to be changed along with the progress of the construction. The building 32 may include an installed object inside or outside a building. The conveying equipment data 53 is used in accordance with the case of performing the calculation of the interference state between the conveyance object and the conveying equipment.

[Example of Kinematic Parameter and Suspension Posture]

FIG. 5 illustrates an example of the suspension posture of the conveyance object based on the kinematic parameter 54 and a predetermined suspension way in the case in which the conveying equipment 33 is a crane device of a predetermined type. The conveyance object 31 illustrates an example of a material having a cylindrical shape. A reference numeral 301 denotes an upper wire of the crane. A reference numeral 302 denotes sling wire of the crane. A reference numeral 303 denotes a hook to which one end of the sling wire 302 is hung. A reference numeral 304 denotes an actual suspension point, at which the other end of the sling wire 302 in a vicinity of both ends of the conveyance object 31 in a longitudinal direction (h) is fixed. A reference numeral 305 denotes a virtual suspension point on the calculation, which corresponds also to the point P that indicates a representative position and a center of gravity of the conveyance object. A reference numeral 501 denotes a length that can be decreased or increased by a mechanism such as an arm of the crane device, and it affects the distance L and the curvature radius r of the arc. A reference numeral 502 denotes a length of the upper wire 301 that affects the movement in the Z direction. A reference sign α denotes an angle formed by rotation about an axis indicated by E of the crane device, and it corresponds to the angle to define the arcuate trajectory. A reference sign φdenotes an angle of rotation about the Z axis as the one angle θ3 to define the suspension posture.

The suspension posture of FIG. 5 is just one example, and a different suspension posture is taken when the shape of the conveyance object, the mechanism of the conveying equipment, the position of the suspension point and the like are different. The basic suspension posture calculation unit 21 calculates the suspension posture like this. Although the conveying equipment is assumed to be the crane device of the predetermined type in this embodiment, the invention is not limited thereto, and can be applied to any device as long as it realizes the arcuate trajectory and the suspension posture.

[Kinematic Parameter and Calculation Model of Suspension Posture]

FIG. 6 illustrates a model for calculation of the suspension posture of the conveyance object using the equation of motion in correspondence with the kinematic parameter 54 in the case in which the conveying equipment is the crane device of the predetermined type corresponding to FIG. 5. A reference numeral 311 denotes a schematic image of a conveyance object, and a reference numeral 312 denotes a center of gravity of the conveyance object 311. At an upper end of the upper wire 301, (X0, Y0 and Z0) are shown as a positional coordinate and a vector, and the kinematic parameter 54 includes an angle θ1 of rotation about an X0 axis and an angle θ2 of rotation about a Y0 axis. An angle θ3 of rotation about a Z0 axis is provided at a location of the hook 303, and this corresponds to the above-described angle φ. At a lower end of the lower wire 302, (X5, Y5 and Z5) are shown as a positional coordinate and a vector, and the kinematic parameter 54 includes an angle θ4 of rotation about an X5 axis and an angle θ5 of rotation about a Y5 axis. A reference sign θi (i=1 to 5) corresponds to a joint angle of the crane device.

In the conveyance object 311 suspended via the lower wire 302, m represents the mass of the conveyance object 311, f represents the force acting on the conveyance object 311, and g represents the gravitational acceleration. The basic suspension posture calculation unit 21 calculates the basic suspension posture by establishing and solving an equation of motion based on the kinematic parameter 54 and the way of suspension in FIG. 5 and the calculation model in FIG. 6.

[Generation and Change of Arcuate Trajectory]

FIG. 7 illustrates an image of the generation of the arcuate trajectory based on the waypoint information. In FIG. 7, (a) illustrates an example in the XY plane. Suppose that the start point P1, the reference point P2 and the end point P3 are given as the waypoints. The start point P1 is set as p(i), the reference point P2 is set as p(i+1), and the end point P3 is set as p(i+2). The trajectory calculation unit 22 draws a line from the reference point P2 to a narrow angle side and sets c(i+1) as the center point C of the arc at a position of the distance L. A reference sign r is a radius of the arc and is a curvature radius. Points q(i) and q(i+1) are waypoints that correspond to a start point and an end point of an arcuate trajectory 700. An arcuate trajectory is set so that the arc is in contact with a line segment between the point P1 and the point P2. Here, m does not represent the mass, but represents a length between the point P2 and the point q(i) and a length between the point P2 and the point q(i+1). Here, d extending from the point P2 represents a vector. When the arcuate trajectory 700 is set, a straight trajectory 701 is set between the point P1 and the point q(i), and a straight trajectory 702 is set between the point P3 and the point q(i+1).

In FIG. 7, (b) illustrates e(i+1) and others as the rotation axis E corresponding to the center point C=c(i+1) of the arc in correspondence with (a) of FIG. 7. An angle α(i+1) is the angle from the start point q(i) to the end point q(i+1) of the arc as the rotation angle about the rotation axis E=e(i+1) of the center point C. The curvature radius r corresponds to a distance between the center point C and the point q(i) or the point q(i+1). The curvature is an inverse number of r, that is, 1/r.

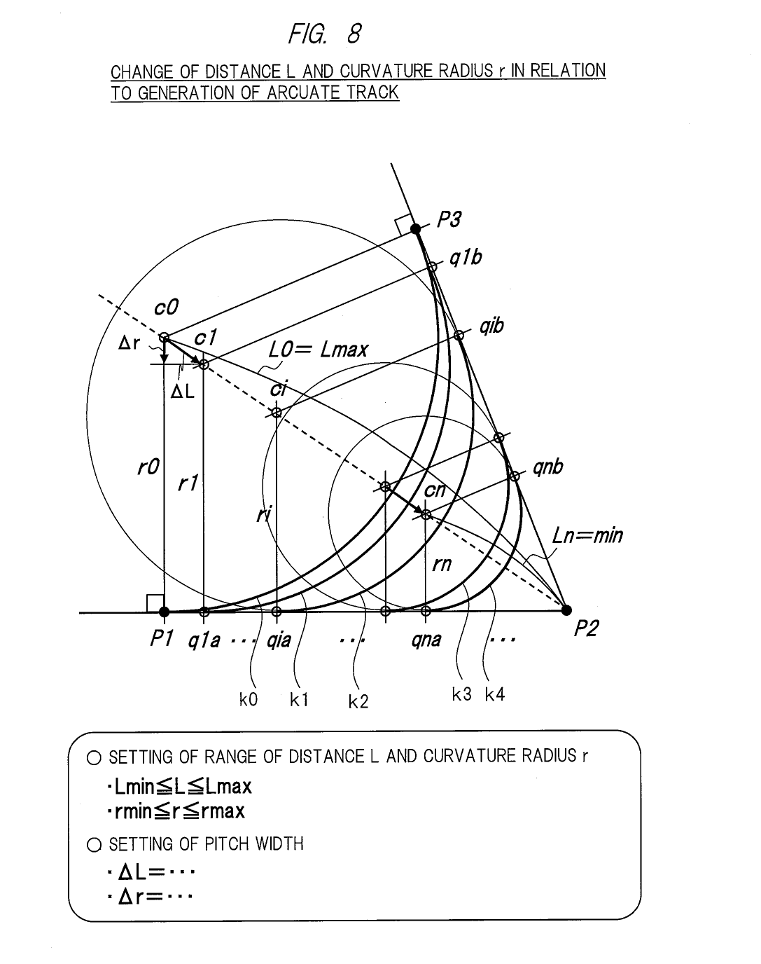

FIG. 8 illustrates changes of the distance L and the curvature radius r of the arcuate trajectory as illustrated in FIG. 7. In FIG. 8, the arcuate trajectory with respect to the waypoints P1, P2 and P3 is simplified by making a length between the points P1 and P2 and a length between the points P2 and P3 equal to each other. {c0, c1, . . . , ci, . . . , and cn} are illustrated as the center point C. {L0, L1, . . . , Li, . . . , and Ln} are illustrated as the distance L corresponding thereto. {r0, r1, . . . ri, . . . , and rn} are illustrated as the curvature radius r corresponding thereto. Arcuate trajectories corresponding to the respective center points C are represented by {k0, k1, . . . ki, . . . , and kn}.

The point P1 is a start point of a maximum arcuate trajectory corresponding to the center point c0, and the point P3 is an end point thereof. At the center point c0, a maximum distance L0=Lmax and a maximum curvature radius r0 are provided. As described above, each candidate of the arcuate trajectory is generated by decreasing the length L by the pitch width ΔL from the initial value L0. For example, the arcuate trajectory at the center point c1 has the distance L=L0−ΔL and points q1a and q1b as the waypoint Q serving as the tangent point of the arc. The minimum distance Lmin and the minimum curvature radius rmin are provided at a center point cn.

It is possible to set the minimum value Lmin and the maximum value Lmax indicating a range that the above-described distance L can take by the above-described kinematic parameter 54 or setting by the operator. Similarly, it is possible to set the minimum value rmin and the maximum value rmax indicating a range that the above-described curvature radius r can take. In addition, it is also possible to set each pitch width ΔL or Δr in the same manner.

When there is interference as the result of the interference determination of S15, the path calculation unit 20 adjusts the distance L between p(i+1) at the point P2 and the center point C by decreasing the distance L by the pitch width ΔL from the initial value L0=Lmax as illustrated in FIG. 8 and the like. By repeating the above-described adjustment, the path calculation unit 20 obtains the maximum possible distance L and curvature radius r with which no interference occurs. More efficient operation of the crane or the like can be achieved with the arcuate trajectory having an as large as possible curvature radius r, that is, having an as small as possible curvature.

[Angle of Suspension Posture]

FIG. 9 illustrates the first angle φ to define the suspension posture. An example in which only angle θ3=φ about the Z axis among the angles (θ1 to θ5) to define the suspension posture is changed in accordance with the kinematic parameter 54 will be described in the first embodiment. Note that, in the case in which the kinematic parameter 54 is different, a process of changing the corresponding different angle is possible in the same manner.

FIG. 9 illustrates an example of the suspension posture of the conveyance object at the start point q(i) of the arc in the case in which there is the arcuate trajectory 700 similar to that of FIG. 7. An angle formed between h which is the longitudinal direction of the conveyance object and t which is a tangential direction of the arc in accordance with the suspension posture is φ. The angle φ has a direction parallel to the tangent of the arc as a reference of 0°. The initial value φ0 of the angle φ about the Z axis is set so that the longitudinal direction of the conveyance object is aligned with t which is the direction parallel to the tangent of the arcuate trajectory. In FIG. 9, the X direction corresponds to the direction t. The angle φ in this case is set to the minimum value φmin=0°. Then, for example, the angle φ is increased in a clockwise direction about the Z axis. The maximum value of the angle φ is set to the maximum value φmax=360°.

It is possible to set the values of the minimum value φmin and the maximum value φmax indicating the range that the above-described angle φ can take based on the kinematic parameter 54 or setting described above. For example, in another setting example, it is possible to set φmin=−90° and φmax=+90°. In addition, it is also possible to set the pitch width Δφ in the same manner. When the operator desires the high-speed calculation, it can be achieved by setting the pitch width Δφ to a larger value, and when the operator desires the high-accurate calculation, it can be achieved by setting the pitch width Δφ to a smaller value.

[Generation of Suspension Posture]

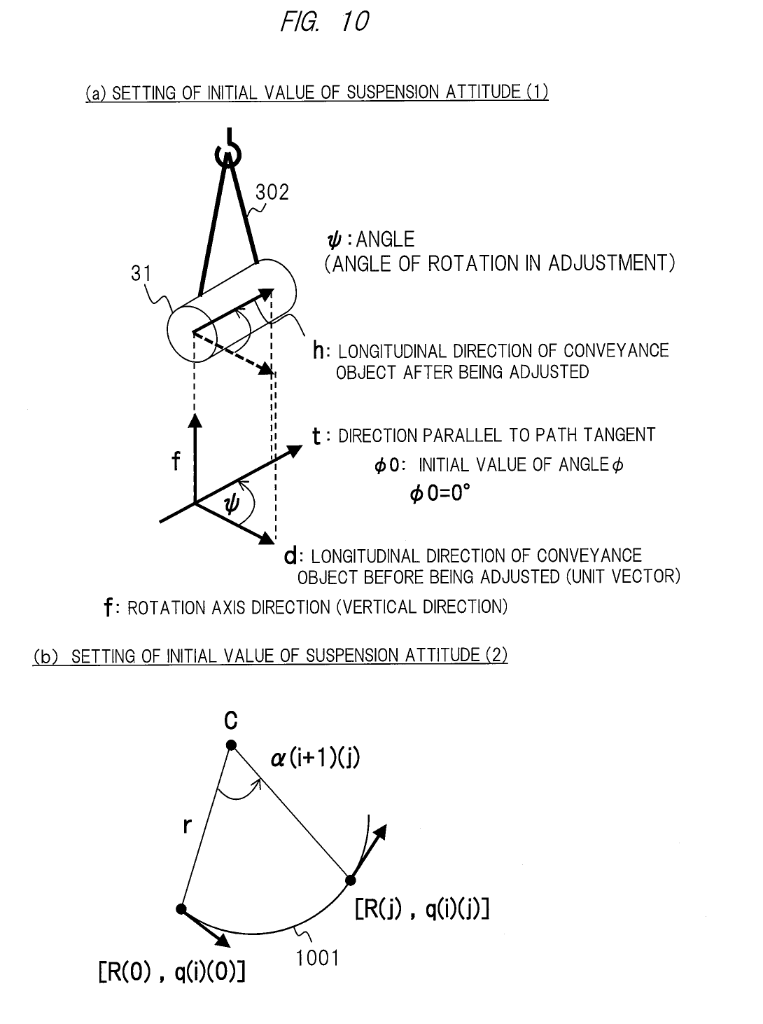

FIGS. 10 and 11 illustrate setting of the initial value of the suspension posture. In FIG. 10, (a) illustrates an example in which the initial value is set by adjusting the angle φ of the suspension posture of the conveyance object 31 similar to that of FIG. 5. A reference sign d denotes the longitudinal direction or a long axis direction of the conveyance object 31 before being adjusted. A reference sign h denotes the longitudinal direction or the long axis direction of the conveyance object 31 after being adjusted. A reference sign t denotes the direction parallel to a path tangent. A reference sign f denotes a direction of the rotation axis and the vertical direction.

When setting the suspension posture, the path calculation unit 20 rotates the angle φ (phi) about the Z axis by the angle ψ (psi) so that the longitudinal direction d of the conveyance object is aligned with the direction t parallel to the path tangent. Accordingly, the path calculation unit 20 sets the initial value φ0 of the angle φ to φ0=0° which is the angle that corresponds to the direction t.

In FIG. 10, (b) illustrates the center point C, the rotation angle α, the curvature radius r, a waypoint q and the like in an arcuate trajectory 1001. The point q represents the interpolation point on the arcuate trajectory. A tangential direction at the point q is represented by [R, q]. A reference sign R denotes a posture at the point q. Suffixes i and j of each reference sign are used in the calculation to be described later.

[Interference Calculation]

FIG. 12 illustrates a process example of the interference calculation and the determination of the candidate on the trajectory by the interference calculation unit 14 of S15. Suppose that the shape of the building 32 and the candidate of the trajectory substantially similar to those of FIG. 4 are provided. Points p1 to p5 are provided as the waypoints on the trajectory, and an arcuate trajectory is provided from the point p2 to the point p4. As an example of the suspension posture of the conveyance object 31 between the points p1 and p2, the longitudinal direction is directed to a Y direction and the angle φ is 90° (the relative value and the absolute value). The angle φ of the suspension posture on the trajectory is relatively maintained. The angle φ is 135° (absolute value) at the point p3 on the arcuate trajectory, and the angle φ is 180° (absolute value) between the points p4 and p5.

The interference calculation unit 14 configures data of an object having the three-dimensional shape of the conveyance object 31 from the conveyance object data 51. The interference calculation unit 14 configures spatial data, in which an object having the three-dimensional shape of the building 32 is developed, from the building data 52. In addition, when there is another data of an object to be a target of the interference calculation, the interference calculation unit 14 configures an object of the data in the same manner. The interference calculation unit 14 arranges the object of the conveyance object 31 in the spatial data of the building 32. The interference calculation unit 17 virtually sets the object of the conveyance object 31 in the state of the angle of the suspension posture at the corresponding position of the point on the trajectory with respect to the candidate of the trajectory including the suspension posture and the arcuate trajectory generated by the path calculation unit 20.

The interference calculation unit 14 performs the interference determination at the position of each point, which is discretized or interpolated in a predetermined manner on the trajectory of the candidate, for example, at each interpolation point with a constant interval ΔP. The path calculation unit 20 sets the interpolation points, which are a plurality of points to be the targets of the interference determination, by using the interval ΔP on the trajectory in the same manner as that in FIG. 11. Note that the high-accurate determination can be achieved by decreasing the interval ΔP and the high-speed determination can be achieved by increasing the interval ΔP.

The interference calculation unit 14 determines the presence or absence of interference with respect to each point and each suspension posture on the trajectory by using a distance between a surface of the conveyance object 31 and a surface of the building 32. The interference calculation unit 14 calculates a distance between a surface of the three-dimensional object of the conveyance object 31 and a surface of the three-dimensional object of the building 32. When the distance is within a predetermined threshold, it is determined as the absence of interference, and when the distance exceeds the threshold, it is determined as the presence of interference. The interference calculation unit 14 sets the presence of interference as the determination result in the unit of the candidate when there is interference even at a point of one position, and sets the absence of interference as the determination result in the unit of the candidate when there is no interference at points of all the positions.

For example, at the position of the point p1, a reference sign W denotes a distance in the Y direction between the surface of the conveyance object 31 and the surface of the building 32. A reference sign W0 denotes an example of threshold for the interference determination. This threshold W0 corresponds to a distance that needs to be secured as a margin between the conveyance object 31 and the building 32. The interference calculation unit 14 calculates the distance W by using the conveyance object data 51 and the building data 52, and compares the distance W and the threshold W0. The interference calculation unit 14 determines the absence of interference when the distance W is equal to or larger than the threshold W0 (W≧W0), and determines the presence of interference in the other case (W<W0).

For example, the candidate at the point p1 has W>W0, and there is no interference. In addition, the candidate at the point p3 has W<W0 with respect to the surface of the building 32 inside the arcuate trajectory, and there is interference. Accordingly, the candidate of the trajectory including a predetermined suspension posture from the point p1 to the point p5 is determined as the presence of interference at the point P3.

Note that the target of the interference determination can include an object installed inside or outside the building 32, for example, a material to be temporarily installed, the conveying equipment and the like. Even when a state of the building 32 is changed along with the progress of the construction, it is possible to perform the calculation of a trajectory including interference determination in the same manner by using the three-dimensional shape data corresponding to the change. The interference calculation unit 14 can perform the calculation and determination of an interference state between the conveyance object and the conveying equipment in the same manner as described above.

In addition, the interference calculation unit 14 may perform the interference calculation after converting each three-dimensional shape of the conveyance object 31 and the building 32 to a simple shape. In addition, the calculation device 1 may be increased in calculation speed by performing the calculations of the interference determination for a plurality of candidates in parallel with using a parallel computing unit. Further, the interference calculation unit 14 is embodied as a mode that determines two values of the presence and absence of interference as the determination of the interference state, but the present invention is not limited thereto, and the interference calculation unit 14 may be embodied as a mode that determines multiple-value states.

[Arcuate Trajectory]

FIG. 13 illustrates an example of the trajectory in the method of changing the distance L and the curvature radius r of the arcuate trajectory as a supplement corresponding to FIG. 8 and the like. As the waypoints Q, q0a and the like denote start points corresponding to the arcuate trajectories each having the distance L, and q0b and the like denote, corresponding end points. In addition, d0 and the like denote points on the arcuate trajectories depending on each distance L here. For example, the arcuate trajectory in the case in which the distance L=L0=Lmax and the curvature radius r=r0=rmax has the center point c0, the start point q0a and the end point q0b and has the point d0 on the arcuate trajectory.

[Calculation of Basic Suspension Posture]

A process example of the calculation of the basic suspension posture by the basic suspension posture calculation unit 21 in S4 of FIG. 2 will be described. The basic suspension posture calculation unit 21 calculates the basic suspension posture based on the following expression using the calculation model of the equation of motion and the kinematic parameter 54 in FIG. 6.

The basic suspension posture calculation unit 21 subdivides the three-dimensional shape of the conveyance object 31 into finite elements of three-dimensional micro cuboids based on the STL file of the conveyance object data 51. The basic suspension posture calculation unit 21 calculates an inertia tensor Bg of the conveyance object 311 of FIG. 6 from the volume of the micro cuboid.

A center of gravity 312(g) of the conveyance object 311 in the calculation model of FIG. 6 is expressed by the equation of motion of the following Expression 1.

$$\begin{matrix} [ Expression 1 ] & \\ \{ \begin{matrix}{F}_{g} = {B}_{g} {A}_{g} + {V}_{g} \times {B}_{g} {V}_{g} \\ {B}_{g} = [ \begin{matrix}{O}_{3} & {mE}_{3} \\ {}_{}^{0}{R}{}_{g}^{} {I}_{g} & {O}_{3}\end{matrix} ] \\ {F}_{g} = [ \begin{matrix}{f}_{t} + mg \\ {m}_{g}\end{matrix} ]\end{matrix} & Expression 1\end{matrix}$$

In Expression 1, Fg is an external force and a torque to be applied to the conveyance object 311. Also, Bg is the inertia tensor. In addition, Vg is an angular velocity and a translational velocity of the conveyance object 311. Furthermore, Ag is an angular acceleration and a translational acceleration of the conveyance object 311. The basic suspension posture calculation unit 21 obtains Vg by solving the equation of motion of Expression 1.

Next, the basic suspension posture calculation unit 21 obtains θ′i (i=1, . . . , and 5), which is a joint angular velocity of the crane device, with using Jacobian matrix in relation to the mechanism of the crane device as J as shown in the following Expression 2. The basic suspension posture calculation unit 21 numerically integrates the joint angular velocity θ′i to derive θi (i=1, . . . , and 5) corresponding to the joint angle of the crane device. Here, θi is the suspension posture.

$$\begin{matrix}[ Expression 2 ] & \\ [ {\begin{matrix}{θ}_{1}^{′} ( k + 1 ) & … & {{θ}_{5}^{′} ( k + 1 ) ]}^{T} = {J}^{- 1} ( k ) {V}_{0} ( k + 1 )\end{matrix} \\ [ {θ}_{1} ( k + 1 ) … {θ}_{5} ( k + 1 ) ]}^{T} = {[ {θ}_{1} ( k ) … {θ}_{5} ( k ) ]}^{T} + Δ {t [ {θ}_{1}^{′} ( k + 1 ) … {θ}_{5}^{′} ( k + 1 ) ]}^{T} & Expression 2\end{matrix}$$

[Generation of Arcuate Trajectory]

A process example of the generation of the candidate of the arcuate trajectory in S13 of FIG. 3 will be described. Here, a waypoint group is set as P=[p(1), p(2), . . . , and p(n)]. In the path information 56, successive three waypoints p(i), p(i+1) and p(i+2) of the waypoint group are specified. The point p(i) is the start point P1 and the point p(i+2) is the end point P3. A reference sign p(i+1) corresponding to the point P2 is a waypoint in the middle of path from the start point P1 to the end point P3. In other words, a first straight trajectory from the point p(i) to the point p(i+1) and a second straight trajectory from the point p(i+1) to the point p(i+2) are provided.

As illustrated in FIG. 7 and the like, the trajectory calculation unit 22 generates the trajectory including the arcuate trajectory that connects the specified waypoints. The trajectory calculation unit 22 generates a trajectory including an arcuate trajectory by using other three waypoints as each unit in the same manner.

The trajectory calculation unit 22 generates a trajectory, which passes an arcuate trajectory without passing the point p(i+1) which is the intermediate waypoint P2, based on the trajectory in accordance with bending of the straight trajectory described above. The trajectory calculation unit 22 sets the point P2 as a reference point for the generation of the arcuate trajectory, and draws a line from the reference point P2 toward the narrow angle side between line segments of the two straight trajectories, thereby setting the center point C of the arcuate trajectory.

Suppose that the center point C of an arc of the arcuate trajectory is set as c(i+1). The distance L is a distance of the straight line segment between p(i+1) corresponding to the reference point P2 and the center point c(i+1). As illustrated in (b) of FIG. 7, the rotation axis corresponding to the center point c(i+1) of the arcuate trajectory is e(i+1). The start point and the end point of the arc are q(i) and q(i+1). The start point q(i) of the arc is a tangent point of the arc with respect to the original straight trajectory between the points P1 and P2. The end point q(i+1) of the arc is a tangent point of the arc with respect to the original straight trajectory between the points P2 and P3. Namely, the original two straight trajectories among the points P1 to P3 become three trajectories including a first straight trajectory 701 from the point p(i) serving as the start point P1 to the point q(i), an arcuate trajectory 700 from the point q(i) to the point q(i+1) and a straight trajectory 702 from the point q(i+1) to the point p(i+2) serving as the end point P2.

The arcuate trajectory 700 is defined by the center point c(i+1) of the arc which is separated from the point p(i+1) by the distance L, the rotation axis e(i+1), the rotation angle α(i+1), the start point q(i) and the end point q(i+1). The curvature radius r which is the radius of the arc is a distance between the center point c(i+1) and each of the start point q(i) and the end point q(i+1).

The calculation expressions of respective variables in the arcuate trajectory are shown in the following Expressions 3 to 6. Expression 3 represents an expression to obtain the center point C of the arc=c(i+1). Expression 4 represents an expression to obtain the curvature radius r. Expression 5 represents an expression to obtain the start point q(i+1) and the end point q(i+2) of the arc. Expression 6 represents an expression to obtain the rotation axis e(i+1) and the rotation angle α(i+1).

$$\begin{matrix}[ Expression 3 ] & \\ {d}_{a} = unit ( p ( i ) - p ( i + 1 ) ) \\ {d}_{b} = unit ( p ( i + 2 ) - p ( i + 1 ) ) \\ d = unit ( {d}_{a} + {d}_{b} ) \\ c ( i + 1 ) = p ( i + 1 ) + L \cdot d \\ & Expression 3 \\ [ Expression 4 ] & \\ m = L \vert {d}_{a} {d}_{b} \vert ( = L \vert {d}_{b} d \vert ) \\ r = \sqrt{{L}^{2} - {m}^{2}} \\ & Expression 4 \\ [ Expression 5 ] & \\ q ( i ) = p ( i + 1 ) + m \cdot {d}_{a} \\ q ( i + 1 ) = p ( i + 1 ) + m \cdot {d}_{b} \\ & Expression 5 \\ [ Expression 6 ] & \\ e ( i + 1 ) = unit ( - {d}_{a} \times {d}_{b} ) \\ α ( i + 1 ) = 2 {tan}^{- 1} ( \frac{m}{r} ) & Expression 6\end{matrix}$$

The calculation device 1 sets the maximum value Lmax in the kinematic parameter 54 as the initial value L0 of the distance L from p(i+1) corresponding to the point P2 to the center point c(i+1) of the arc in the calculation of the trajectory as described above. This setting of L0=Lmax corresponds to a concept of generating an arc with an as large as possible curvature radius r, that is, the arc with an as small as possible curvature. In the example of FIG. 8, the start point P1, the end point P3, the center point c0, the maximum distance L0=Lmax and the maximum curvature radius r0 are set in the maximum arcuate trajectory k0.

The angle φ of the suspension posture of the conveyance object 31 on the arcuate trajectory is illustrated in FIG. 9 and the like described above. The posture on the arcuate trajectory 700 between the start point q(i) and the end point q(i+1) of the arc is set so that an angle of an inclination of the posture with respect to the path traveling direction is coincident with an angle of an inclination of the posture on the straight trajectory between the point p(i) and the point q(i). Namely, the angle φ is set so that the long axis direction h of the conveyance object 31 is directed along the direction t parallel to the path tangent with respect to the trajectory between the point p(i) and the point q(i) as illustrated in FIG. 10 and the like described above. Also in the line segments obtained by dividing and approximating the arcuate trajectory between the point q(i) and the point q(i+1) and at the points on the arcuate trajectory, the angle φ is set so that the long axis direction h of the conveyance object 31 is directed in the tangential direction t of the arc.

In FIG. 7 described above, the trajectory calculation unit 22 obtains the center point c(i+1) of the arc having the distance L from p(i+1) corresponding to the point P2 by using Expression 3. In Expression 3, a unit vector in a direction from the point p(i+1) to the point p(i) is set as da, and a unit vector in a direction from the point p(i+1) to the point p(i+2) is set as db. A vector obtained by unitizing a vector in which da and db are added (da+db) is set as d. The trajectory calculation unit 22 sets a point, which is moved in parallel from the point p(i+1) by a length of the distance L in a direction of the vector d, as the center point c(i+1) of the arc.

The trajectory calculation unit 22 obtains the curvature radius r, which is the radius of the arc, by using the distance L from Expression 4. In this case, m represents the mass of the conveyance object 311 in the calculation model of FIG. 6. A right triangle is formed of a line segment from the point p(i+1) toward the center point c(i+1) and a line segment from the point p(i+1) to the point p(i). The remaining one side corresponds to the radius r of the arc which is a line segment from the center point c(i+1) to the point p(i).

The trajectory calculation unit 22 obtains the point q(i) and the point q(i+1), which are two tangent points between the arc and the straight trajectories by Expression 5. The point q(i) and the point q(i+1) can be obtained from the point p(i+1), m and the unit vectors da and db described above.

The trajectory calculation unit 22 obtains the rotation axis e(i+1) and the rotation angle α(i+1) of the arcuate trajectory by Expression 6. The rotation axis e(i+1) is a unit vector obtained by inverting a sign of a cross product vector d=(da+db) of the unit vector da and the unit vector db obtained previously. The rotation angle α(i+1) can be obtained by multiplying a tangent of the right triangle formed by the values derived in Expression 4 by 2.

[Initial Value of Suspension Posture]

An initial posture and an interpolated posture of the suspension posture will be described. As described above, the suspension posture of the conveyance object 31 on the arcuate trajectory as an initial value is set so that the angle φ (relative value) with respect to the arc tangential direction is not changed at each position before and after traveling on the arcuate trajectory in the first embodiment. Namely, the angle φ of the predetermined initial posture set at the start point of the trajectory is relatively maintained even in the interpolated posture at each interpolation point in the movement on the trajectory. The absolute value of the angle in the absolute coordinate system is changed depending on a degree of bending of the trajectory.

The path calculation unit 20 sets the initial value φ0 of the angle φ of the suspension posture of the conveyance object at the start point of the trajectory so that the longitudinal direction of the conveyance object is aligned with the arc tangential direction based on the basic suspension posture and the setting information 55 as illustrated in FIG. 9 and the like described above. Namely, with the arc tangential direction at the rotation angle α and the start point q(i) of the arc being a reference of 0°, the angle φ is set to be φ0=0°. Then, the path calculation unit 20 adjusts a value of the angle φ to be increased or decreased within the range when the result of the interference determination described above with respect to the candidate of the suspension posture is the presence of interference.

The operator can set the initial value of the angle of the suspension posture to be φ0=0° in advance. In addition, the operator can set a value of the angle φ0 to a different value, for example, φ0=90° in consideration of the kinematic parameter 54.

In addition, information of the angle of the suspension posture may be specified together with the waypoint as the path information 56 to be given as an initial input. For example, the angle φ of the suspension posture at the start point P1 is specified by the operator. In such a case, the path calculation unit 20 directly uses the specified angle of the suspension posture. In addition, when the angle of the suspension posture at an end point of the first trajectory has already been determined in the case of the connection of a plurality of trajectories, the angle may be taken over at a start point of the next second trajectory.

As illustrated in (b) of FIG. 10, an interpolation point on the arcuate trajectory is represented as q(i)(j). A posture at the interpolation point q(i)(j) is represented as R(j). The posture R(j) is obtained by rotating a posture R(0) at a start point q(i)(0) by a rotation angle α(i+1)(j) about the rotation axis e(i+1) to the interpolation point q(i)(j).

[Single Trajectory and Plurality of Trajectories]

In the trajectory calculation system according to this embodiment, the operator can select and use the methods described below.

(1) The calculation device 1 sets a trajectory including three waypoints as a unit path, and calculates a trajectory including optimal suspension posture and arcuate trajectory independently for each unit path. In this case, any change of an angle of the suspension posture or the like between the unit paths is not considered. The trajectory is calculated while setting an initial value of the angle φ to the above-described φ0 for each unit path.

(2) The calculation device 1 calculates a trajectory including comprehensively optimal suspension posture and arcuate trajectory in a trajectory formed by succession of a plurality of unit paths. In this case, the calculation device 1 considers the change of the angle of the suspension posture or the like between the unit paths. Thus, the calculation device 1 considers taking over the suspension posture between the unit paths. The calculation device 1 recommends a path with the smallest change as a preferred trajectory. The path evaluation unit 15 performs the evaluation process from the viewpoint of whether the suspension posture is maintained or changed between the plurality of trajectories.

[Path Evaluation Process]

FIG. 18 illustrates examples of the trajectory and the evaluation process relating to the description above. FIG. 18 illustrates the example of the method in which the angle φ of the suspension posture is changed. As the viewpoint of evaluation, when a plurality of successive trajectories are calculated based on the plurality of waypoints, it is considered how the arcuate trajectory and the suspension posture in each trajectory should be set in order to obtain totally preferred path with the inclusion of the connection between the trajectories.

The first trajectory K1 and the second trajectory K2 are illustrated as the successive trajectories. The first trajectory K1 is a unit path from a start point A1 to an end point A3 and includes an arcuate trajectory kA. The second trajectory K2 is a unit path from a start point B1 to an end point B3 and includes an arcuate trajectory kB. The end point A3 of the first trajectory K1 and the start point B1 of the second trajectory K2 are connected by a straight trajectory, or are the same point (A3=B1).

Suppose that the angle φ of the suspension posture at the end point of the first trajectory K1 is 90°, and the angle φ of the suspension posture at the start point of the second trajectory K2 is 0° as a result of generation of the trajectory. In this case, it is necessary to change the angle φ of the suspension posture from 90° to 0° between the end point A3 and the start point B1. A load on the operation of the conveying equipment or the conveyor arises due to this change. It is desirable that such a change of the angle of the suspension posture is minimized from the viewpoint of efficiency.

Thus, the trajectory calculation system of the first embodiment recommends a path having the minimum change of the angle of the suspension posture as the preferred trajectory with respect to the trajectory formed by the succession of the plurality of unit paths. The path evaluation unit 15 calculates a total amount of change of the angle φ of the suspension posture in the trajectory formed by the succession of the plurality of unit paths by using the information of the suspension posture and the trajectory of the plurality of unit paths obtained in S5. The path evaluation unit 15 gives a high evaluation to a path with a minimum total amount of change of the angle φ of the suspension posture, and recommends the path as a comprehensively preferred trajectory. In addition, the path evaluation unit 15 may output a plurality of candidates of the trajectory in the order of smaller to larger total amount of change.

Similarly, it is desirable that the angle of the suspension posture at each point on the trajectory is maintained as far as possible also in one unit path such as the first trajectory K1 or the second trajectory K2. The path evaluation unit 15 gives a high evaluation to a path with the minimum amount of change of the angle of the suspension posture in one unit path, and recommends the path as the preferred trajectory.

As described above, when viewed as one unit path, the case in which the initial value of the angle φ of the suspension posture is set to the angle φ0=0° which is parallel to the path tangential direction is often optimal. However, when viewed as the succession of the plurality of unit paths as described above, it is preferable to set the initial value of the angle φ of the suspension posture to a different angle other than the angle φ0=0° in some cases. Namely, for example, there is a case in which an angle of the suspension posture at the end point of the first trajectory KA is preferably taken over directly as an angle of the suspension posture at the start point of the second trajectory KB.

Thus, the trajectory calculation system of the first embodiment calculates and recommends a preferred trajectory in which the angle (the relative value on the trajectory) of the suspension posture on each unit path is kept unchanged as far as possible from the start point to the end point in the case of the calculation of the trajectory formed of the plurality of successive unit paths as described above.

In the case of employing the method in which the calculation is performed by taking over the angle of the suspension posture between the unit paths, the calculation device 1 starts the calculation of, for example, the second trajectory KB by setting the initial value of the angle φ of the suspension posture at the start point B1 to be the same as the angle φ of the suspension posture at the end point A3 of the first trajectory KA.

[Screen]

FIG. 19 illustrates an example of the screen of the calculation device 1 of the trajectory calculation system according to the first embodiment. In this screen, a reference numeral 191 denotes an item of a menu, and the operator can select the item to be executed. For example, items for path generation, path confirmation, setting and the like are included. When the item for the path generation or the path confirmation is selected, for example, information denoted by a reference numeral 192 and subsequent reference numerals is displayed.

As the items denoted by the reference numeral 192 and subsequent reference numerals, the information of the trajectory calculated by the trajectory calculation system is displayed. The reference numeral 192 denotes an item that allows the operator to select the trajectory, and identification information and a name of the trajectory to be selected are displayed. A reference numeral 193 denotes an item that displays contents of the trajectory selected by 192. The item 193 displays information such as the identification information, the name, the waypoint, the trajectory and the like as the information of the contents of the trajectory. The item 193 graphically displays the state of conveyance of the conveyance object on the trajectory including the arcuate trajectory and the suspension posture in a form of a three-dimensional or two-dimensional animation video or still image as described above. In the example of the item 193, the same information as that of FIG. 4 described above is illustrated in a two-dimensional manner. It is also possible for the operator to confirm a state of the suspension posture and the like at a desired position and point of time by manipulating a button, a bar or the like in the item 193.

A reference numeral 194 denotes an item that displays information of the arcuate trajectory in the information of the trajectory. The item 194 displays the information regarding the entire arcuate trajectory constituting the trajectory of 192 or the arcuate trajectory selected by the operator. The information to be displayed includes identification information and the center point, the start point, the end point, the curvature radius and the like constituting the arcuate trajectory.

A reference numeral 195 denotes an item that displays information of the suspension posture in the information of the trajectory. For example, the item 195 displays the angle information to define the suspension posture at a position of each waypoint on the trajectory of 192. For example, the angle (θ1, θ2 and θ3=φ) of the suspension posture at the position of the point p1 is displayed.

[Example of Arcuate Trajectory and Interference Determination]

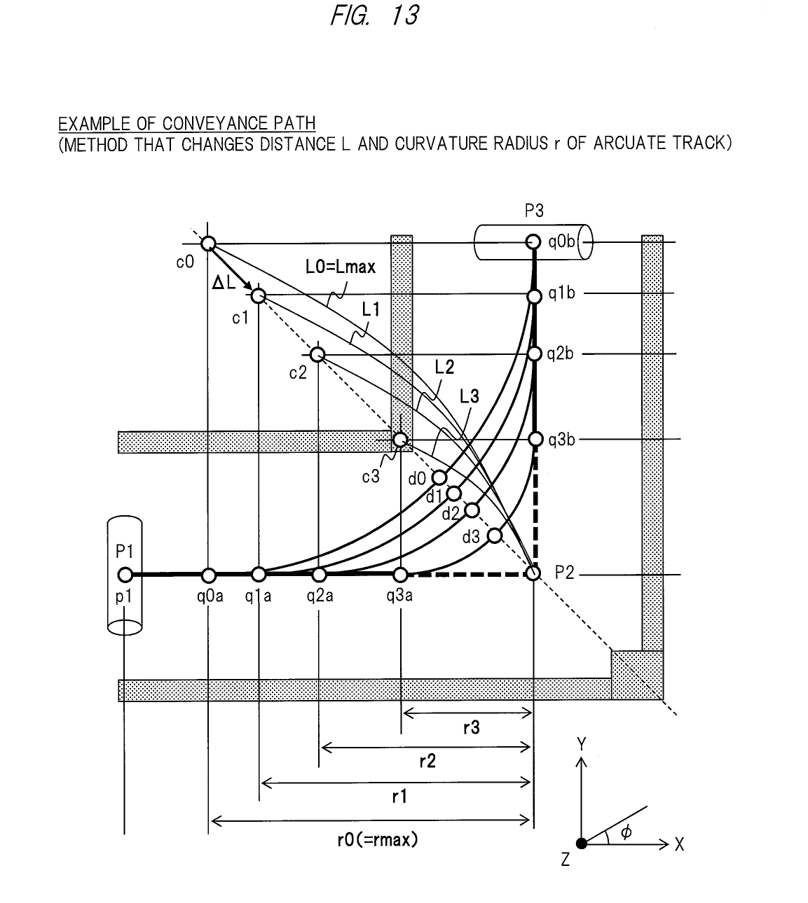

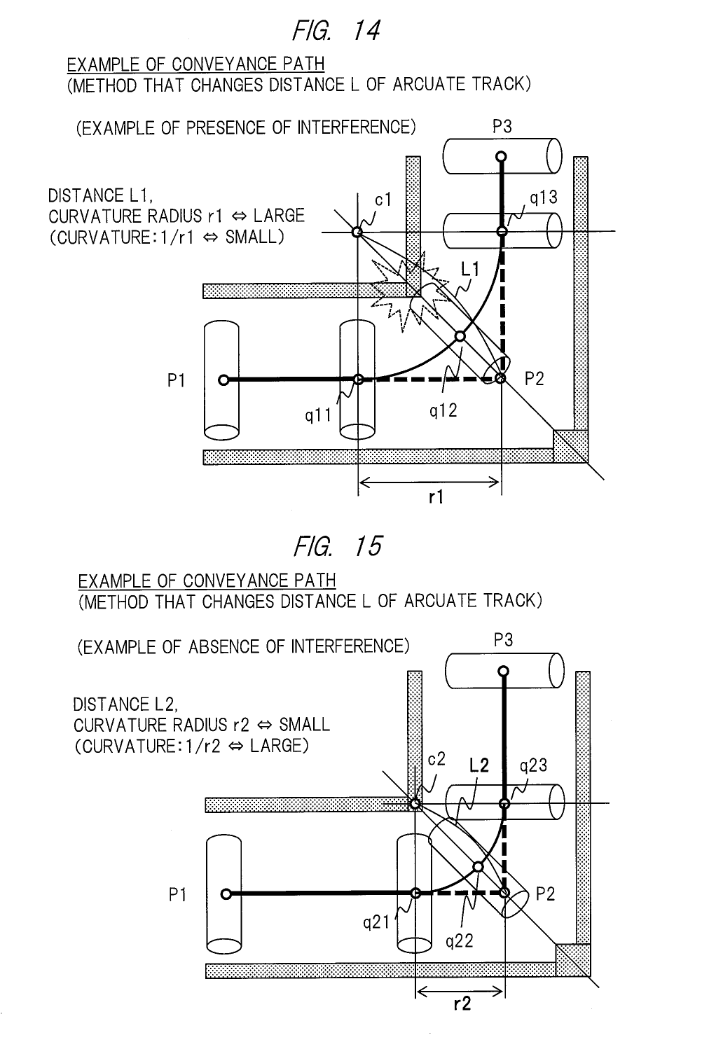

FIGS. 14 and 15 illustrate examples in which the candidate of the trajectory is generated by adjusting the distance L and the curvature radius r of the arcuate trajectory as the supplement of the arcuate trajectory and the interference determination. FIG. 14 illustrates the example in the case of the presence of interference and FIG. 15 illustrates the example in the case of the absence of interference.

The example of FIG. 14 illustrates the candidate of the arcuate trajectory in which the distance L is set to a large distance L1. The angle φ of the suspension posture is 90° as a relative value at a point p12 on the arcuate trajectory. The result of the interference determination at this point p11 is the presence of interference.

The example of FIG. 15 illustrates the candidate of the arcuate trajectory in which the distance L is decreased from the example of FIG. 14 to be a relatively small distance L2. The angle φ of the suspension posture at a point p22 on the arcuate trajectory is the same as that of the example of FIG. 14, and the result of the interference determination is the absence of interference.

[Example of Suspension Posture and Interference Determination]

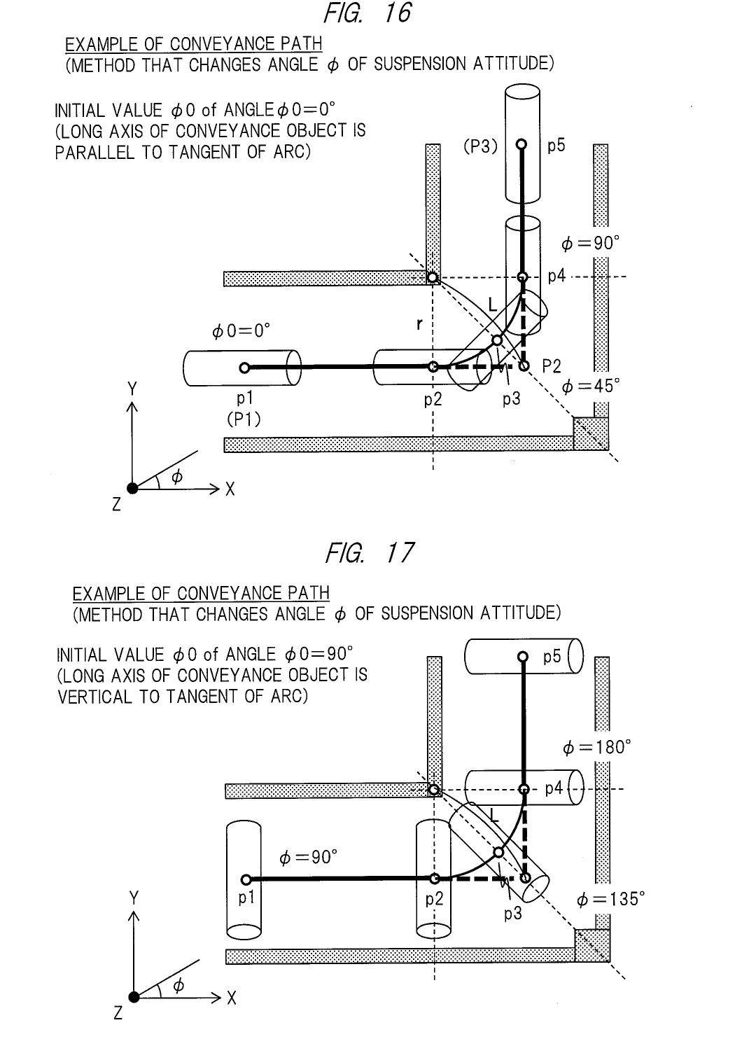

FIGS. 16 and 17 illustrate examples in which the candidate of the trajectory is generated by adjusting the angle φ of the suspension posture as the supplement of the suspension posture and the interference determination. FIG. 16 illustrates the example in which the initial value φ0 of the angle φ at the start point of the trajectory is set to 0°, and FIG. 17 illustrates the example in which the initial value φ0 of the angle φ at the start point of the trajectory is set to 90°. The distance L of the arcuate trajectory is the same in both FIGS. 16 and 17.

As described above, the angle φ0=0° of FIG. 16 is the angle at which the longitudinal direction of the conveyance object is aligned with the direction parallel to the arc tangent, and the angle is relatively maintained on the trajectory. In the example of FIG. 16, absence of interference is determined at each point on the trajectory. In the example of FIG. 17, the distance W between the conveyance object 31 and the building 32 decreases compared with that of the example of FIG. 16, and presence of interference is determined depending on the threshold W0 described above.

### Second Embodiment

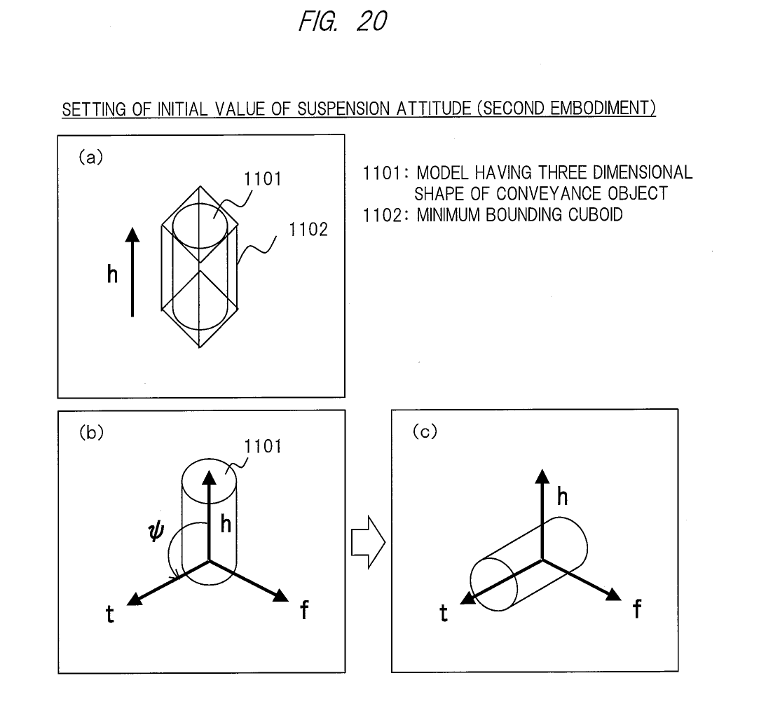

A trajectory calculation system according to the second embodiment of the present invention will be described with reference to FIG. 20. As described above, the basic suspension posture of the conveyance object is calculated from the equation of motion based on the calculation model as illustrated in FIG. 6 in the first embodiment. In the second embodiment, in the process in relation to the calculation or setting of the basic suspension posture of S4, the basic suspension posture is automatically set based on a three-dimensional shape of a conveyance object instead of being derived from the equation of motion so that a tangent of a trajectory and a longitudinal direction of the conveyance object are set to be parallel to each other.

FIG. 20 illustrates a process of setting an initial value of a suspension posture based on the three-dimensional shape of the conveyance object in the calculation device 1 of the trajectory calculation system according to the second embodiment. The basic suspension posture calculation unit 21 automatically calculates and sets the initial value φ0 of the angle φ of the suspension posture by using a model having the three-dimensional shape of the conveyance object 31 in the conveyance object data 51.

In (a) of FIG. 20, a reference numeral 1101 denotes a cylindrical shape as an example of a polygonal model having a three-dimensional shape of the conveyance object 31 based on the STL file of the conveyance object data 51. A reference numeral 1102 denotes a minimum bounding cuboid that encloses the three-dimensional shape of the cylindrical shape 1101. The calculation device 1 calculates the longitudinal direction h of the conveyance object 31 from the three-dimensional shape like the minimum bounding cuboid 1102. A reference sign t denotes a vector of the tangent of the above-described arcuate trajectory.

In (b) of FIG. 20, the calculation device 1 rotates the model having the shape like 1101 by the angle ψ with respect to the angle φ, so that the long axis or the longitudinal direction h of the conveyance object 31 is aligned with the direction t parallel to the path tangent. Accordingly, the state of the angle of the suspension posture as illustrated in (c) of FIG. 11 is acquired. A reference sign f denotes the above-described rotation axis direction, around which the conveyance object 31 is rotated so that the long axis or the longitudinal direction of the conveyance object 31 is aligned with a tangent vector t. A reference sign ψ denotes an angle at such rotation.

The basic suspension posture calculation unit 21 of the second embodiment obtains the rotation axis f and the rotation angle ψ described above by the following Expression 7.

$$\begin{matrix}[ Expression 7 ] & \\ f = unit ( d \times t ) \\ ϕ = {tan}^{- 1} ( \frac{d \times t}{d \cdot t} ) & Expression 7\end{matrix}$$

In FIG. 10 described above, d corresponds to a unit vector obtained by projecting the longitudinal direction h of the conveyance object to a plane on which the arcuate trajectory is present. When the unit vector d and the tangent vector t are not parallel to each other, the basic suspension posture calculation unit 21 derives the angle ψ formed between the unit vector d and the tangent vector t in the case in which the unit vector d is rotated to the tangent vector t in the following method. Namely, the basic suspension posture calculation unit 21 derives the rotation axis f from a cross product vector of d and t (d×t). As shown in Expression 7, the rotation angle ψ is derived as a tangent of the right triangle formed by the cross product vector of d and t (d×t) and two sides obtained by projecting d to t.

### Effects and Others

As described above, in the trajectory calculation system according to the first embodiment and the second embodiment, it is possible to calculate a trajectory including preferable suspension posture and arcuate trajectory without interference in relation to the calculation of the trajectory in the suspension conveyance using conveying equipment such as the crane. Accordingly, it is possible to achieve the reduction in construction period and construction cost.

In the foregoing, the invention made by the inventors of the present invention has been concretely described based on the embodiments. However, it is needless to say that the present invention is not limited to the foregoing embodiments and various modifications and alterations can be made within the scope of the present invention.

### REFERENCE SIGNS LIST

1 calculation device
11 data input unit
12 setting unit
13 path information input unit
14 interference calculation unit
15 path evaluation unit
16 data output unit
20 path calculation unit
21 basic suspension posture calculation unit
22 trajectory calculation unit
23 posture calculation unit
31 conveyance object
32 building
33 conveying equipment
51 conveyance object data
52 building data
53 conveying equipment data
54 kinematic parameter
55 setting information
56 path information
57 interference calculation data
58 path evaluation data
59 screen display data
60 waypoint data
61 basic suspension posture data
62 trajectory data
63 posture data
101 control unit
102 storage unit
103 operation input unit
104 screen display unit
105 communication unit
150 design device

1. A trajectory calculation system comprising:
a calculation device that performs a process of calculating a trajectory on which a conveyance object is conveyed on a trajectory including an arcuate trajectory by conveying equipment with a suspension posture between waypoints inside a building,
wherein the calculation device includes:
a storage unit that stores three-dimensional shape data of the building, three-dimensional shape data of the conveyance object, a kinematic parameter of the conveying equipment and waypoint information;
a trajectory calculation unit that generates a candidate of the trajectory including the arcuate trajectory by using the waypoint information;
a posture calculation unit that generates a candidate of the suspension posture of the conveyance object by using the three-dimensional shape data of the conveyance object and the kinematic parameter of the conveying equipment;
an interference calculation unit that determines an interference state between the suspension posture of the conveyance object on the trajectory and the building with respect to a candidate of the trajectory including the candidate of the arcuate trajectory and the candidate of the suspension posture;
a path calculation unit that determines a trajectory including the arcuate trajectory and the suspension posture with which no interference occurs between the conveyance object and the building; and
a display unit that displays information including the determined trajectory.

2. The trajectory calculation system according to claim 1,
wherein when a result of the determination is presence of interference, the trajectory calculation unit generates a candidate in which a curvature radius of the arcuate trajectory is changed in accordance with the kinematic parameter of the conveying equipment, and
the path calculation unit determines a trajectory with a small amount of change from an initial value of the curvature radius of the arcuate trajectory.

3. The trajectory calculation system according to claim 1,
wherein when a result of the determination is presence of interference, the posture calculation unit generates a candidate in which an angle of the suspension posture is changed in accordance with the kinematic parameter of the conveying equipment, and
the path calculation unit determines a trajectory with a small amount of change from an initial value of the angle of the suspension posture.

4. The trajectory calculation system according to claim 2,
wherein the trajectory calculation unit sets the initial value of the curvature radius of the arcuate trajectory to a maximum value in accordance with the kinematic parameter of the conveying equipment.

5. The trajectory calculation system according to claim 2,
wherein the trajectory calculation unit generates the arcuate trajectory from first, second and third points in the waypoint information, while setting a tangent point of an arc, which is in contact with a first line segment that connects the first and second points and a second line segment that connects the second and third points, with the first line segment as a start point of the arcuate trajectory, and setting a tangent point of the arc with the second line segment as an end point of the arcuate trajectory, and
the trajectory calculation unit generates the candidate of the arcuate trajectory by increasing or decreasing a distance between the second point and a center point of the arc and a curvature radius of the arc, which define the arcuate trajectory, by a predetermined unit.

6. The trajectory calculation system according to claim 3,
wherein the posture calculation unit sets the initial value of the angle of the suspension posture to an angle at which a long axis direction of the conveyance object is maintained relatively in a direction parallel to a tangent of the arcuate trajectory.

7. The trajectory calculation system according to claim 3,
wherein the posture calculation unit generates the candidate of the suspension posture by increasing or decreasing a first angle, which defines the suspension posture, by a predetermined unit.

8. The trajectory calculation system according to claim 1, further comprising:
a basic suspension posture calculation unit,
wherein the basic suspension posture calculation unit calculates the suspension posture of the conveyance object by the conveying equipment based on an equation of motion in accordance with the kinematic parameter of the conveying equipment, and sets the calculated suspension posture as a basic suspension posture for the generation of the candidate of the suspension posture.

9. The trajectory calculation system according to claim 1, further comprising:
a basic suspension posture calculation unit,
wherein the basic suspension posture calculation unit calculates a suspension posture of the conveyance object by calculating a long axis direction of the conveyance object from a model having a three-dimensional shape of the conveyance object data and rotating the model so that the long axis direction is aligned with a direction of a tangent of the trajectory, and sets the calculated suspension posture as a basic suspension posture for the generation of the candidate of the suspension posture.

10. The trajectory calculation system according to claim 1, further comprising:
a basic suspension posture calculation unit,
wherein the basic suspension posture calculation unit displays a three-dimensional shape of the conveyance object on a screen by using the conveyance object data, and sets a suspension posture of the conveyance object by the conveying equipment, which is adjusted by moving and rotating the conveyance object based on an operation of an operator on the screen, as a basic suspension posture for the generation of the candidate of the suspension posture.

11. The trajectory calculation system according to claim 1, further comprising:
a basic suspension posture calculation unit,
wherein the basic suspension posture calculation unit sets a suspension posture, which is selected based on an operation of an operator among a plurality of patterns of the suspension posture set in advance, as a basic suspension posture for the generation of the candidate of the suspension posture.

12. The trajectory calculation system according to claim 1,
wherein the storage unit stores three-dimensional shape data of the conveying equipment,
the interference calculation unit determines an interference state between the suspension posture of the conveyance object and the conveying equipment on the trajectory with respect to the candidate of the trajectory by using the three-dimensional shape data of the conveying equipment, and
the path calculation unit determines a trajectory without interference between the conveyance object and the conveying equipment.
